(19) United States
(12) Patent Application Publication
(10) Pub. No.: US 2026/0071805 A1
(43) Pub. Date: Mar. 12, 2026

(54) MULTI-TEMPERATURE STORAGE AND RETRIEVAL SYSTEM

(71) Applicant: Ocado Innovation Limited, Hatfield (GB)

(72) Inventor: Ian PARKS, St Albans (GB)

(21) Appl. No.: 19/391,324

(22) Filed: Nov. 17, 2025

Related U.S. Application Data
(63) Continuation of application No. PCT/EP2024/063809, filed on May 17, 2024.

(30) Foreign Application Priority Data
May 19, 2023 (GB) 2307525.2

(51) Int. Cl. F25D 13/04; B65G 1/04; F25D 21/14

(52) U.S. Cl. CPC F25D 13/04; B65G 1/0464; F25D 21/14

(57) ABSTRACT

A multi-temperature storage system, including: a grid framework structure (GFS) including: a supporting framework structure (SFS) including storage columns arranged to accommodate storage containers, said SFS including a load bearing assembly of supporting walls at least one of which is a thermally insulating panel that separates the storage columns into first and second groups to define temperature storage zones; a track system for guiding movement of robotic load handling devices on the GFS mounted to the SFS and including a tracks arranged in a grid pattern including grid cells extending across the storage cells such that each modular storage cell supports a sub-group of two or more grid cells of the track system; a radiant cooling system including a cooling unit and a closed network of tubing in fluid communication with the cooling unit, the closed network extending in the first temperature storage zone.

### TECHNICAL FIELD

The present invention relates to the field of storage and retrieval systems comprising robotic load handling devices operative on tracks located on a grid framework structure for handling storage containers stacked in the grid framework structure, and storage containers for use in such storage and retrieval systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, the storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 11. Each grid in the grid framework structure has at least one storage column 11 for storage of a stack of containers. FIG. 1 is a schematic perspective view of the grid framework structure 14, and FIG. 2 is a top-down view showing a single stack 12 of containers 10 arranged within the framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

The grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a substantially horizontal plane and supported by the upright members 16. The members 16, 18, 20 are typically manufactured from metal and typically welded or bolted together or a combination of both. The storage containers 10 are stacked between the upright members 16 of the grid framework structure 14, so that the grid framework structure 14 guards against horizontal movement of the stacks 12 of the storage containers 10, and guides vertical movement of the storage containers 10.

The top level of the grid framework structure 14 includes a track system 15 comprising a plurality of rails or tracks 22 arranged in a grid pattern across the top of the stacks 12. Referring additionally to FIG. 3, the rails 22 support a plurality of load handling devices or robotic load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. The track system 15 can be integrated into the grid structure in the sense that the first and second sets of tracks are respectively integrated into the first and second set of grid members. Alternatively, the track system 15 can be separate to the grid structure in the sense that the first and second sets of tracks are respectively mounted to the first and second sets of grid members. Each load handling device 30 comprises a vehicle body 32 which is arranged to travel in the X and Y directions on the tracks or rails 22 of the grid frame structure 14, above the stacks 12 (see FIG. 4). FIGS. 4 and 5 shows a load handling device 30 described in PCT Patent Publication No. WO2015/019055 (Ocado Innovation Limited) and International patent application WO 2015/140216 (Ocado Innovation Limited) comprising a vehicle body 32 equipped with a lifting mechanism 33 comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

To grab a container 10, the grabber device 39 comprises four locating pins or guide pins nearby or at each corner of the grabber device 39 which mate with corresponding cut outs or holes formed at four corners of the storage container 10 and four gripper elements arranged at the bottom side of the grabber device 39 to engage with the rim of the storage container 10. The locating pins help to properly align the gripper elements with corresponding holes in the rim of the container. Each of the gripper elements comprises a pair of wings or legs that are collapsible to be receivable in corresponding holes in the rim of the storage container and an open enlarged configuration having a size greater than the holes in the rim of the storage container 10 in at least one dimension so as to lock onto the storage container 10. The wings are driven into the open configuration by a drive gear (not shown). More specifically, the head of at least one of the wings comprises a plurality of teeth that mesh with the drive gear such that when the gripper elements are actuated, rotation of the drive gear causes the pair of wings to rotate from a collapsed configuration to an open enlarged configuration.

The vehicle body 32 comprises an upper part and a lower part (see FIG. 5 (a and b)). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that is are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism comprising a winch, as shown in FIG. 5 (a and b). When in the recess, the container is lifted clear of the rails beneath, so that the load handling device can move laterally to a different location. Whilst the container receiving space 40 is shown in FIG. 4 arranged within the vehicle body 32, the container receiving space can be located below a cantilever as described in WO2019/238702 (Autostore Technology AS).

A typical storage and retrieval system 1 is shown in FIG. 3, and has a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

Upon receipt of a customer order, a robotic load handling device operative to move on the tracks is instructed to pick up a storage bin containing the item of the order from a stack in the grid framework structure and transport the storage bin to a pick station whereupon the item can be retrieved from the storage bin. Typically, the load handling device transports the storage bin or container to a bin lift device that is integrated into the grid framework structure. A mechanism of the bin lift device lowers the storage bin or container to a pick station. Alternatively, the storage bin is lowered by the lifting mechanism of the robotic load handling device to the pick station.

A grid framework structure normally has at least one grid cell or storage column which is used not for storing storage containers, but which comprises a location where the load handling devices can drop off and/or pick up storage containers so that they can be transported to a second location (not shown in the prior art figures) where the storage containers can be accessed from outside of the grid framework structure or transferred out of or into the grid framework structure. Within the art, such a location is normally referred to as a “port” and the grid cell or storage column in which the port is located may be referred to as a “delivery column”. The storage columns typically comprise two delivery columns. A first delivery column may, for example, comprise a dedicated drop-off port where the robotic load handling vehicles or load handling vehicles can drop off storage containers to be transported through the delivery column and further to the pick station, and a second delivery column may comprise a dedicated pick-up port where the robotic load handling vehicles can pick up storage containers that have been transported through the second delivery column from the pick station, i.e. storage containers are fed into the pick station via the first delivery column and exit the access station via the second delivery column.

At the pick station, the item is retrieved from the storage bin. Picking can be done manually by hand or by a robot. After retrieval from the storage bin, the storage bin is transported to a second bin lift device whereupon it is lifted to grid level to be retrieved by a load handling device and transported back into its location within the grid framework structure. Alternatively, the storage bin can be picked up by the lifting mechanism of the robotic load handling device through the pick-up port. A control system and a communication system keeps track of the location of the storage bins and their contents within the grid framework structure.

As individual storage containers are stacked in vertical layers in storage columns, their locations in the grid framework structure or “hive” may be indicated using co-ordinates in three dimensions to represent the load handling device or a container’s position and a container depth (e.g. container at (X, Y, Z), depth W). Equally, locations in the grid framework structure may be indicated in two dimensions to represent the load handling device or a container’s position and a container depth (e.g. container depth (e.g. container at (X, Y), depth Z). For example, Z=1 identifies the uppermost layer of the grid, i.e. the layer immediately below the rail system, Z=2 is the second layer below the rail system and so on to the lowermost, bottom layer of the grid.

To erect the grid framework structure in the art, a plurality of vertical uprights are individually positioned one piece at a time in a grid-like pattern on the ground. The assembling of individual vertical uprights together one piece at a time is sometimes referred to as a “stick-built” structure. The “stick-built” approach of the assembling the grid framework structure requires numerous time-consuming adjustments to be made for reliable operation of the robotic load handling devices on the tracks. The height of the vertical uprights and thus the level of the grid mounted thereon is adjusted by one or more adjustable feet at the base or bottom end of each of the vertical uprights. A sub-group of the vertical uprights are braced together to provide structural stability to the grid framework structure. The vertical uprights are interconnected at their top ends by grid members so that the grid members adopt the same grid pattern as the vertical uprights, i.e. the vertical uprights support the grid members at the point or node where each of the grid members intersect in the grid pattern. For the purpose of explanation of the present invention, the points or junctions where the grid members intersect or are interconnected constitute the nodes of the track system and correspond to the area where the track system is supported by a vertical upright. The resultant grid framework structure can be considered as a free standing rectilinear assemblage of upright columns supporting the grid formed from intersecting horizontal grid members, i.e. a four wall shaped framework.

The arrangement of the vertical uprights provides multiple vertical storage columns for the storage of one or more containers in a stack. The vertical uprights help to guide the grabber device of the lifting mechanism as the grabber device engages with a container within the grid framework structure and is lifted towards the load handling device operative on the grid. The size of the grid framework structure and thus the ability to store containers containing different items or stock keeping units (SKUs) is largely dependent on the number of vertical uprights spanning over a given footprint of the grid framework structure. However, one of the biggest bottlenecks in the building of a fulfilment or distribution centre is the erection of the grid framework structure. The time and cost to assemble the grid framework structure represents a huge proportion of the time and cost to build a fulfilment or distribution centre. The biggest and the most time consuming operation involves erecting the vertical uprights individually and fixing the track system to the vertical uprights.

As electronic commerce (e-commerce) continues to grow and overtake conventional brick and mortar retail practices, many businesses are facing challenges of maintaining or gaining relevance in an online marketplace and being able to compete with prominent players in the space. A typical supply chain involve the storage and retrieval of a large number of different products. For example, e-commerce and retail platforms that sell multiple product lines require systems that are able to store hundreds of thousands of different product lines having different temperature storage requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. For example, where an order of one or more items involves the delivery of food and grocery goods that are of a perishable nature, storage of goods must adhere to strict temperature and environmental requirements, e.g. chilled or frozen temperature. For example, some types of food require a chilled temperature environment (typically temperatures between 1°C to 8°C), some types of food require an even colder temperature environment (typically temperatures lower than -15°C), and other types of food require a higher temperature environment (typically temperatures above 10 °C).

Conventional multi-temperature storage and retrieval systems typically require a separate walk-in cooler or freezer to be pre-constructed or additional components to be installed around the existing storage and retrieval system discussed above, which substantially expands the footprint of the storage and retrieval system and increases the cost and complexity of installing and operating the storage and retrieval system across multiple environmentally controlled zones. As a result, there has been a need for a freestanding, high density, automated storage and retrieval system with multiple integrated, environmentally controlled zones that removes the need of separate walk-in, environmentally controlled zones that operate independently of the storage and retrieval system.

In an attempt to adapt an existing automated storage and retrieval system to provide storage for temperature sensitive items, e.g. chilled or frozen items, WO2015124610 (Autostore Tech AS) relates to a storage system for receiving and storing processed refrigerated and frozen food products where there is provided thermal insulation between at least a section of the grid structure and the remotely operated vehicle. The system comprises insulating covers arranged in the top level of the grid structure. The insulating covers provide a thermal barrier towards the remotely operated vehicle as well as contributing to maintaining the desired temperature in the bins in the grid structure. The insulating covers are arranged to be movable by means of the remotely operated vehicle. The vehicle can move one insulating cover to another cell in the grid, or hold it temporarily while a bin is removed from the stack.

WO2021198170 (Autostore Tech AS) relates to an automated storage and retrieval system for storing specialized goods in storage containers in an isolating housing, having walls and a roof. Openable and closable hatches are arranged in the roof. A storage tower is arranged inside the isolating housing such that the storage tower being accessible to a container handling vehicle though the hatch. The storage tower has a number of vertically stacked, horizontally movable container supports in the form of shelves upon which may rest a plurality of storage containers and one or more openings corresponding in size to a storage container such that storage containers may pass therethrough. The container supports may align their openings to form a tower port beneath a hatch, through which the container handling vehicle may lower its lifting device though the hatch, down the tower port, and access the target container.

In both teachings, there is a requirement that the thermal insulation covering of the grid cell has to be removed or moved aside so that a container handling vehicle operating on the grid structure is able to gain access to one or more storage containers in storage. Not only does this introduce an additional step when retrieving storage containers from the storage system but there is no guarantee that the thermal insulation covers of the grid cells will provide adequate insulation to prevent the ingress of warmer air into the grid structure from the ambient region above the grid structure. However, the use of thermal insulation covers for each of the grid cells introduces an additional complexity of the need to be easily removal in order to gain access to one or more storage container in storage in the grid structure. To mitigate this problem, a fleet of robotic load handling devices are disposed in a chilled, or freezer environment. In these facilities, the robotic load handling devices reside and operate in the chilled or freezer environment on a full-time basis. Whilst having a fleet of load handling devices operating in the chilled or freezer environment on a full-time basis automates the storage and retrieval of storage containers from the storage system, there will be occasions where one or more load handling devices would have to be taken out service. This could be as a result of a breakdown or malfunction of the load handling device or simply the need to service the load handling device. In both cases, access to the load handling device would be required by maintenance personnel. However, in the case where the load handling device resides in the freezer environment, which can be low as -30°C, this introduces another problem of the health and safety of the maintenance personnel working at such low temperatures.

WO2021209648 (Ocado Innovation Ltd) teaches a multi-temperature storage system comprising temperature-control means configured to maintain a first-temperature region within the storage structure at a first temperature and a second-temperature region within the storage structure at a second temperature. The temperature-control means includes a temperature-control plant or chill plant and tubing providing a closed loop along which temperature-control fluid is configured to flow from the temperature-control plant to the first- temperature region within the storage structure and from the first-temperature region within the storage structure to the temperature-control plant. In an embodiment of WO2021209648 (Ocado Innovation Ltd), the tubing comprises outbound ducting having multiple branches which diverge from a single outlet of the chill plant that direct chilled air from the chill plant to different regions in the storage structure. For example, one branch of the outbound ducting may direct chilled air from the chill plant to the top of a stack of containers via an outlet of the ducting. The chilled air may then descend to the bottom of the stack, chilling the products in the containers in the stack. Multiple branches of the ducting may in some examples be directed to the same region. To accommodate the tubing within the grid framework, the tubing is arranged to extend through one or more storage columns reducing the storage capacity of the grid framework structure. To mitigate occupying valuable storage space in the grid framework structure, in another embodiment of WO2021209648 (Ocado Innovation Ltd), the tubing is located within and extends along the vertical uprights which support the track system to transfer a chilled fluid from the chill plant to one or more regions of the storage structure. However, locating the tubing within the vertical uprights not only limits the exposure of the tubing within the storage structure but also limits the flexibility of distributing the chilled fluid within the storage structure to the warmer regions of the storage structure. In an attempt to mitigate this problem, it is necessary that the tubing has a complicated arrangement of straight sections and helical sections, the helical sections providing a greater exposure of the chilled fluid.

Thus, there is a need for an automated storage and retrieval system for storing frozen or chilled items without the shortcomings discussed above.

### SUMMARY OF THE INVENTION

In comparison to a forced convention type cooling system in which cool air from a chill plant is blown into the storage columns of the grid framework structure, cooling within the storage columns according to the present invention is by radiant cooling. Radiant cooling is the use of cooled surfaces to remove heat primarily by thermal radiation and only secondarily by other methods such as convection. Radiant cooling systems remove the need for a blower and therefore offers the potential of lower energy consumption than conventional cooling systems known in the art such as forced convection type cooling systems.

As the environment below the track system is largely static and is primarily disrupted by the movement of the storage containers being lifted or lowered through the track system via the grid cells, any forced movement of air besides convection within the grid framework structure is usually minimum. Heat entering the storage columns, particularly in the upper portion of the grid framework structure via the grid cells as a result of one or more storage containers being lifted or lowered through the grid cells, can be readily exchanged by tubing or conduits carrying a heat transfer fluid extending within the upper portion of the grid framework structure. As radiant cooling is concentrated within the grid framework structure, i.e. below the track system, the area or region above the track system is shielded or protected from radiant cooling. Any exposure to the cooling effects of the radiant cooling system on one or more robotic load handling devices operative on the track system will, therefore, be a minimum. Heat is mainly radiated from the storage containers in one or more stacks below the track system. As a result, one or more robotic load handling devices can operate in a relatively stable temperature environment in comparison to the environment below the track system when moving across different temperature zones but yet be able to access storage containers stored at the different temperatures. This increases the longevity of the one or more load handling devices operative on the track system at low temperatures, in particular the charge held by the battery. Other benefits include preventing one or more areas of the robotic load handling device suffering from the effects of condensation when moving from a cold environment to a warmer environment when trying to access storage containers stored in different temperature zones. In some instances, the condensation risk of moving a robotic load handling device from a cold area to a warmer area may affect one or more electrical components of the robotic load handling device. For example, condensation can lead to electrical shorting and/or bad electrical contacts. Both effects can compromise the reliability of the respective circuitry and/or can even lead to the destruction of the circuitry or at least one of components of the circuitry. Furthermore, condensation will lead to corrosion effects, shortening the lifetime of the circuitry and / or the build-up of moisture on the robotic load handling devices.

The present invention has mitigated the above problems and benefits from the energy efficiency of a radiant cooling system by providing a multi-temperature storage system, comprising:

A) a grid framework structure, said grid framework structure comprising:

a) a supporting framework structure comprising a plurality of storage columns, each of the plurality of storage columns being arranged to accommodate a stack of storage containers, said supporting framework structure comprising a load bearing assembly of supporting walls arranged in a three dimensional grid pattern comprising a plurality of modular storage cells for the storage of a plurality of stacks of storage containers, said at least one of the supporting walls is a thermally insulating panel being arranged to separate the plurality of storage columns into a first group of storage columns to define a first temperature storage zone and a second group of storage columns to define a second temperature storage zone;

b) a track system for guiding the movement of the one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system;

B) a radiant cooling system comprising a cooling unit and a closed network of tubing in fluid communication with the cooling unit, the closed network of tubing extending in the first temperature storage zone for circulating a heat transfer fluid to exchange heat with at least a portion of the first temperature storage zone such that the first temperature storage zone is at a lower temperature than the second temperature storage zone.

The radiant cooling system works by absorbing heat radiated from the environment within the grid framework structure in the first temperature storage zone including objects in storage such as storage containers and their contents. The first temperature storage zone is defined as the volume occupied by the first group of the plurality of storage columns and extends from the floor to the track system. As the air within the grid framework structure is largely static only to be disrupted by one or more storage containers being lifted or lowered through a grid cell, movement of air within the grid framework structure largely occurs by convection. Warm air, particularly in the lower portion of the grid framework structure, rises towards the track system only to be absorbed by the network of tubing carrying the heat transfer fluid in the upper portion of the grid framework structure.

However, the deployment of a network of tubing carrying a heat transfer fluid within the grid framework structure would not only impact the storage capacity of grid framework structure but can also affect the structural integrity of the grid framework to support one or more robotic load handling devices which can weigh up to 150kg. In the traditional “stick-built” approach of constructing the supporting framework structure, individual vertical uprights are first erected one at a time to form multiple storage columns for storing a plurality of storage containers in a stack and the track system is mounted to the plurality of vertical uprights by interconnecting the upper ends of the vertical uprights by a plurality of intersecting grid members in a grid pattern forming the track system comprising a plurality of grid cells or grid spaces. As the vertical uprights are load bearing, the network of tubing would encroach one or more storage columns of the grid framework structure and affect the storage capacity of the grid framework structure.

In comparison to the “stick-built” approach of constructing the supporting framework structure, the supporting framework structure according to the present invention is formed from a load bearing assembly of supporting walls that are arranged in a three dimensional grid pattern comprising a plurality of modular storage cells. Each of the plurality of modular cells provided by the three dimensional grid pattern defines a storage space for storing one or more stacks of storage containers. Optionally, the load bearing assembly of supporting walls comprises a plurality of prefabricated frames. Thus, the supporting framework structure is formed from an assembly of prefabricated frames and at least one thermally insulating panel. The supporting walls are load bearing in the sense that, when assembled together to form the supporting framework structure, they provide a load bearing structure to support one or more robotic load handling devices moving on the track system mounted to the supporting framework structure. As a result, the modular storage cells provide sufficient spacing within the grid framework structure to accommodate at least a portion of the closed network of tubing carrying a heat transfer fluid without affecting the storage capacity of the plurality of storage columns. The size of the modular storage cells is such that each of the plurality of modular storage cells supports a sub-group of two or more grid cells of the track system. For example, each of the modular storage cells is sized to accommodate an array of 4 by 4 grid cells of the track system and therefore is able to accommodate 16 stacks of storage containers. The arrangement of the prefabricated frames permits at least a portion of the network of tubing to be fed through the supporting framework structure without affecting the storage capacity of the grid framework structure.

At least one of the plurality of supporting walls is a thermally insulating panel that is arranged in the supporting framework structure to separate the plurality of storage columns into a first group of storage columns to define the first temperature storage zone and a second group of storage locations to define the second temperature storage zone. The closed network of tubing extends in the first storage zone circulating a heat transfer fluid to exchange heat with at least a portion of the first temperature storage zone such that the first temperature storage zone is at a lower temperature than the second temperature storage zone.

Preferably, the radiant cooling system is configured to regulate the temperature of the air in the first temperature storage zone at a temperature in the range 0°C to 8°C to define a chilled temperature zone. For the storage of goods that do not require any specialized storage temperature, the second temperature storage zone can be kept at the same temperature as the temperature of the air above the track system, i.e. at ambient temperature. Depending on the season, the ambient temperature can range from 4°C in the winter to as high as 30°C in the summer.

As heat enters the region below the track system via the grid cells of the track system, the rate by which the heat transfer fluid at a given temperature can exchange with the heat entering the first temperature storage zone is very much dependent on the temperature difference between the environment above and below the track system. This is because radiant cooling relies heavily on removing the heat by thermal radiation. The greater the temperature difference of the environment above and below the track system in the first temperature storage zone, the greater that work needs to be done by the radiant cooling system below the track system, in particular the cooling unit, to exchange heat with the warm air entering the first temperature storage zone from above the track system via one or more grid cells. Examples of cooling units include but are not limited to a refrigerated unit and an example of a heat transfer fluid comprises glycol. Optionally, the heat transfer fluid can be any one of ethylene glycol, silicone oil, water etc., and compatible mixtures of such fluids, e.g. a mixture of water and glycol at a lower cost.

Conversely, the smaller the temperature difference of the environment above and below the track system in the first temperature storage zone, the less work that needs to be done by the radiant cooling system to regulate the temperature of the air in the first temperature storage zone and thus, the quicker the temperature of the air in the first temperature zone is able to reach a predetermined temperature. In the case, where the goods in storage in the first temperature zone are chilled grocery items, e.g. milk, cheese, etc., the predetermined temperature is in the chilled temperature range, e.g. 0°C to 8°C. The longer the radiant cooling system takes to cool the air in the first temperature zone, the greater the risk of spoiling temperature sensitive goods in storage in the first temperature zone. Considering that the volume of air in the region around the portion of the closed network of tubing in the first temperature storage zone is relatively small in comparison to the environment above the track system, cooling of warm air entering the first temperature storage zone via one or more the grid cells by heat exchange with the heat transfer fluid flowing through the tubing is relatively quick. In an aspect of the present invention, the cooling capacity of the radiant cooling system can be controlled by controlling the radiant cooling surface area of at least a portion of the closed network of tubing with the surrounding air in the first temperature storage zone. Increased heat exchange between the heat transfer fluid and the surrounding air occurs by increasing the surface area of at least a portion of the closed network of tubing within the first temperature storage zone and vice versa. The cooling capacity of the network of tubing is dependent on maximising the surface area of the cooling tubes with the environment within the grid framework structure which in turn is dependent on the arrangement of the tubes within the grid framework structure. To increase the radiant cooling surface area in the first temperature storage zone, optionally, a portion of the closed network of tubing may comprise a plurality of parallel tubes extending substantially horizontally in the first temperature storage zone. Instead of a single tube extending through the first temperature storage zone carrying the heat transfer fluid, the network of tubing may be broken up into a plurality of parallel tubes, thereby increasing the surface area of the heat transfer fluid that is exposed to the surrounding environment. To conserve space within the first temperature storage zone for the storage of stacks of storage containers whilst still increasing the surface area of the heat transfer fluid to the surrounding environment, optionally, the plurality of tubes are arranged in a vertical plane and/or in a horizontal plane.

By breaking down the at least portion of the network of tubing into a plurality of parallel tubes increases the radiant cooling surface area with the surrounding environment. Increasing the density of tubing carrying the heat transfer fluid within the grid framework structure also increases the cooling capacity of the radiant cooling system. Optionally, each set of the plurality of tubes being arranged in an array pf parallel tubes, the parallel tubes being spaced apart within the array. Optionally, the closed network of tubing comprises a plurality of sets of parallel tubes, each of the plurality of sets of parallel tubes extending substantially horizontally between two or more of the storage columns of the first group of the plurality of storage columns. Having a plurality of sets of parallel tubes extending substantially horizontally between two and more of the storage columns of the first group of the plurality of storage columns increases exposure of the network of tubing to the stacks of storage containers within the first temperature storage zone and thereby, increases the exchange of heat radiated from the storage containers.

Optionally, the first temperature storage zone comprises an upper portion and a lower portion, the portion of the closed network of tubing extends in the upper portion of the first temperature storage zone to distribute a heat transfer fluid at a supplied pressure to exchange heat within the upper portion of the first temperature storage zone. As warm air rises and cold air descends, to maximise the cooling efficiency in the first temperature storage zone, the closed network of tubing is concentrated in the upper portion of the grid framework structure. The cooling capacity of the radiant cooling system is dependent on the proportion of the network of tubing accommodated in the upper portion of the first temperature storage zone. More effective absorption of the heat within the grid framework structure occurs when the upper portion represents a significant proportion of the height of the grid framework structure. Thus, heat entering the first temperature storage zone via one or more grid cells is exchanged by the heat transfer fluid in the upper portion of the first temperature storage zone. To provide effective cooling within the first temperature storage zone, in accordance with the present invention, the height of the upper and lower portions may be in the ratio 1:X, where X represents the lower portion and is in the range between 1 to 10. Thus, for the at least portion of the network of tubing to occupy 50% of the height of the grid framework structure, X is equal to 1. Less than 50%, X is greater than 1. Optionally, the lower portion of the first temperature zone is substantially free of the parallel tubes extending substantially horizontally in the first temperature storage zone.

As the storage containers are stored in stacks in the one or more storage columns in the first temperature storage zone, the uppermost storage containers in one or more stacks are more vulnerable to heating than the lowermost storage containers since the uppermost storage containers are closer to the track system. The closer the uppermost storage containers is to the track system, the greater is the risk of warming of the uppermost storage containers. Conversely, the closer the at least portion of the network of tubing is to the track system, the greater is the ability of the radiant cooling system to be able to exchange heat entering the track system via one or more grid cells.

To increase the cooling capacity of the radiant cooling system, optionally, a second portion of the closed network of tubing extends through at least a portion of the track system extending across the first temperature storage zone. To accommodate the at least portion of the network of tubing within the track system, optionally, the track system comprises a plurality of track supports being arranged in a grid pattern corresponding to the grid pattern of the plurality of tracks to define a track support structure, said plurality of tracks being mounted to the plurality of track supports, and wherein the second portion of the closed network of tubing extends across the first temperature storage zone or preferably, through at least a portion of the track support structure extending across the first temperature storage zone.

Cool air in the upper portion of the first temperature storage zone descends towards the lower portion of the first temperature storage zone to be replaced by warm air rising to the upper portion of the first temperature storage zone to continually maintain the temperature of the lower portion of the first temperature storage zone at a predetermined temperature. Thus, the one or more storage containers and their contents in the lower portion of the first temperature storage zone are kept cool by the cool air descending from the upper portion of the first temperature storage zone.

The foundation upon which the grid framework structure rests represents a relatively large thermal mass, usually composed of concrete, in comparison to the surrounding environmental within the first temperature storage zone. If the temperature of the foundation is at a higher temperature than the set-point temperature of the environment within the first temperature storage zone, and considering that the foundation represents a large thermal mass, the foundation will be radiating heat into the first temperature storage zone. As the foundation is a large thermal mass, the impact from the radiant cooling system to keep the storage containers in the lower portion of the first temperature storage zone at a lower temperature may be minimal. In a worst case scenario, the heat radiated from the foundation may warm one or more storage containers in the lower portion of the first temperature storage zone or at least prevent the one or more storage containers and their temperature sensitive contents from reaching a safe storage temperature. In the case, of chilled goods such as milk, cheese, etc, this may result in spoiling of the temperature sensitive goods. According to food safety standards, chilled goods should only be stored at temperatures in the range 0°C to 8°C and can only outside these temperature for a maximum of 4 hours, by which they are deemed unfit for human consumption. Due to the large thermal mass of the foundation, to try and displace the heat radiated from the foundation by the radiant cooling system in the upper portion of the first temperature storage zone would take a very long time. To mitigate this problem, the radiant cooling system can additionally extend into the foundation upon which the plurality of storage containers rests. Optionally, a third portion of the closed network of tubing extends below the first group of storage columns in the first temperature storage zone. Thus, in addition to exchanging heat with the environment in the upper portion of the first temperature storage zone, the closed network of tubing can also extend below the group of storage columns in the first temperature storage zone.

Preferably, the multi-temperature storage system comprises a subfloor for supporting the grid framework structure and a screed arranged on top of the subfloor in the first temperature zone, said third portion of the closed network of tubing extending within the screed. For the purpose of definition, a ‘screed’ is a layer of load bearing material (usually consisting of cement and sand) laid on top of a subfloor. The screed thermally isolates the subfloor from the storage containers. To thermally isolate the screed from the subfloor, preferably, the screed is thermally insulated from the subfloor.

The closed network of tubing extending through the screed exchanges heat stored within the screed and regulates the temperature of the screed at a predetermined temperature, which is usually lower than the temperature of the environment within the first temperature storage zone. This mitigates any heat stored in the screed having a negative impact on the temperature of one or more storage containers in the lower portion of the first temperature storage zone. Moreover, the heat in the lower portion of the first temperature zone can also readily exchange heat with the screed which is kept cool by the heat exchange fluid flowing through the third portion of the closed network of tubing. As a result, the cooling unit will not have to work so hard to regulate the temperature within the first temperature storage zone to a predetermined storage temperature.

To distribute the heat transfer fluid to the different portions of the closed network of tubing, optionally, the closed network of tubing further comprises at least one common distribution system for distributing heat exchange fluid from the cooling unit to each of the plurality of substantially parallel tubes. Optionally, the closed network of tubing further comprises at least one common return system in fluid communication with the cooling unit, and wherein at least a portion of the closed network of tubing is arranged to form one or more parallel circulation loops extending from the at least one common distribution system to the at least one common return system for circulating the heat transfer fluid from the at least one distribution system to the first temperature zone and from the first temperature zone to the cooling unit. Optionally, the at least common distribution system comprises a feed manifold and the at least one common return system comprises a return manifold.

To control the flow of the heat transfer fluid through the closed network of tubing and thereby regulate the transfer the heat with the heat transfer fluid optionally, the at least one common distribution system comprises at least one control valve to control the flow of the heat transfer fluid to one or more of the plurality of substantially parallel tubes.

To accommodate the closed network of tubing within the first temperature storage zone without affecting the storage capacity of the grid framework structure, the grid framework structure may further comprise a plurality of tote guides for guiding the plurality of storage containers through the grid cells of the track system, wherein the closed network of tubing extends through a portion of the plurality of tote guides in the first temperature storage zone.

As the supporting framework structure comprising the assembly of supporting walls in the present invention are largely load bearing, at least a portion of the network of tubing can be fed through the plurality of tote guides without affecting the load bearing capacity of the grid framework structure. In an aspect of the present invention, the grid framework structure further comprises a plurality of tote guides for guiding the plurality of storage containers through the grid cells of the track system, and wherein at least a portion of the closed network of tubing extends through a portion of the plurality of tote guides in the first temperature storage zone. To extend through the portion of the plurality of tote guides in the first temperature storage zone, optionally, the portion of the plurality of tote guides in the first temperature storage zone comprises a plurality of sets of tote guides, each set of the plurality of sets of tote guides comprises a pair of tote guides formed as a single body. Optionally, each set of the plurality of sets of tote guides comprises a plurality of openings that are spaced apart, and wherein at least portion of the closed network of tubing extends through the plurality of openings. Optionally, each set of the plurality of sets of tote guides is formed from one or more bends in a sheet metal blank extending longitudinally along the sheet metal blank to form two substantially perpendicular bin guiding plates defining two tote guides.

It is strictly not necessary to constrain all four corners of a storage container when guiding the storage container vertically through a grid cell. Optionally, the plurality of tote guides are arranged at diagonal opposed corners of the plurality of storage columns for guiding diagonally opposing corners of a storage container through a grid cell. Guiding the storage containers vertically along diagonally opposed corners of the storage containers not only reduces congestion with the grid framework structure but reduces the overall cost of the grid framework structure.

Radiant cooling offers the benefit of lower energy consumption and the ability to be accommodated into the grid framework structure rather than having separate grid framework structures and having dedicated load handling devices operating on the different grid framework structures. However, to cool the first temperature storage zone at a temperature below the ambient room temperature, the temperature of the heat transfer fluid flowing through the closed network of tubing is usually less than the temperature of the surrounding air so as to absorb heat from the surrounding air. As a result, the temperature of the closed network of tubing extending through the first temperature storage zone may reach a temperature below the dew point temperature of the environment within the first temperature storage zone resulting in condensation of the moisture in the air on the closed network of tubing. The effects of condensation increase when air from above the track system enters the first temperature storage zone via the grid cells. To prevent water condensed on the closed network of tubing from dripping onto the storage containers and spoiling their contents, optionally, the system further comprises a run-off system for capturing condensation from a portion of the closed network of tubing, said run-off system comprising a network of gutters extending substantially longitudinally along the portion of the closed network of tubing.

The network of gutters extends below the network of tubing carrying the heat transfer fluid for capturing water condensed on the tubing. Optionally, the run-off system comprises a downpipe having an inlet opening for capturing fluid from the network of gutters and an outlet opening external of the grid framework structure. Water captured by the network of gutters is fed into a downpipe which is taken away externally of the grid framework structure, e.g. a drainage system. To direct the water captured by the network of gutter to the downpipe, optionally, each gutter of the network of gutters is downwardly inclined towards the downpipe. The ability of the downpipe to take away the water in the network of gutters depends on the flow rate of the water through the downpipe. To prevent water overflowing the network of gutters before entering the downpipe, the run-off system can, optionally, comprise a pump for pumping the water captured by the network of gutters to a drainage system. The pump increases the flow rate of water flowing out of the downpipe externally of the grid framework structure and thereby, preventing the network of gutters from overflowing.

Whilst radiant cooling offer the benefits of a low cost cooling system in a multi-temperature storage and retrieval, the efficiency of the radiant cooling system to maintain the temperature in the first temperature storage zone at a predetermined temperature is very much dependent on the impact of any external heat entering the storage and retrieval system. Any heat radiated externally into the storage and retrieval system places increased demands on the radiant cooling system to exchange heat with the heat transfer fluid. One such area of external heat entering the first temperature storage zone is from above the track system, e.g. heat radiated from the sun, and is very much dependent on the weather. To mitigate heat from external sources entering the first temperature storage zone and thereby, placing increased demands on the radiant cooling system, optionally, the system further comprises a shield extending across the track system above the first group of storage columns. For example, the shield provides an insulating barrier or “umbrella” above the plurality of the first group of the plurality of storage columns from heat radiated from above the track system placing increased demands on the radiant cooling system. To further mitigate the transfer of heat into the first temperature storage zone, optionally, the first temperature storage zone comprises an enclosure housing the first group of the plurality of storage columns, at least one wall of the enclosure comprises the thermally insulating panel. The enclosure being such that the track system extends above the enclosure across the first temperature storage zone and the second temperature storage zone. As cold air descends towards the lower portion of the first temperature storage zone, there is a risk of a rapid ingress of heat from external sources should personnel enter the enclosure via the lower portion of the first temperature storage zone. Personnel may need to enter the first temperature storage zone to inspect the storage containers and their contents. To provide access for personnel to enter the enclosure via the lower portion of the first temperature storage zone, optionally, the enclosure is accessible via a second enclosure having a first opening accessible externally of the second enclosure and a second opening linking the second enclosure with the enclosure, the first opening being closeable by a first door to prevent access to the second enclosure and the second opening is closeable by a second door to isolate the second enclosure from the enclosure. The second enclosure functions as an “air lock” between the outside environment and the enclosure housing the first group of the plurality of storage columns.

Optionally, the system may comprise a plurality of load handling devices for lifting and moving containers stacked in the stacks, the plurality of load handling devices being remotely operated to move laterally on the track system above the plurality of storage columns to access the storage containers through the grid cells, each of said plurality of load handling devices comprising:

a) a wheel assembly for guiding the load handling device on the track system;

b) a container-receiving space located above the track system; and

c) a lifting device arranged to lift a storage container from a stack into the container-receiving space.

### BRIEF DESCRIPTION OF THE DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention.

FIG. 2 is a schematic diagram of a top down view showing a stack of bins arranged within the framework structure of FIG. 1.

FIG. 3 is a schematic diagram of a system of a known robotic load handling device operating on the grid framework structure.

FIG. 4 is a schematic perspective view of the load handling device showing the container receiving space within the body of the load handling device.

FIGS. 5(a) and 5(b) are schematic perspective cut away views of the load handling device of FIG. 4 showing (a) a container accommodating a container receiving space of the load handling device and (b) the container receiving space of the load handling device.

FIG. 6 is a perspective view of the grid framework structure according to an embodiment of the present invention.

FIG. 7 is a perspective view of the prefabricated braced frame used to assemble the grid framework structure shown in FIG. 6.

FIG. 8 is a perspective view of a dual temperature grid framework structure according to an embodiment of the present invention showing a first temperature storage zone comprising a radiant cooling system and a second temperature storage zone in the ambient temperature region.

FIG. 9 is a perspective side view of the dual temperature grid framework structure shown in FIG. 8 showing a closed network of tubing of the radiant cooling system in the upper portion of the first temperature storage zone.

FIG. 10(a and b) is a schematic of the first temperature storage zone where (a) is a side view of the first temperature storage zone showing a network of tubing of the radiant cooling system carrying a heat transfer fluid extending through the first temperature storage zone; and (b) is a cross-sectional view of the of the first temperature storage zone showing the arrangement of the network of tubing within the first temperature storage zone.

FIG. 11 is a perspective overhead view of the grid framework structure showing the track system extending across the supporting framework structure.

FIG. 12 is a perspective isometric view showing the network of tubing of the radiant cooling system in the upper portion of the first temperature storage zone.

FIG. 13 is a perspective view of the distribution of the network of tubing in the upper portion of the supporting framework structure of the first temperature storage zone.

FIG. 14 is a perspective view of a cross section of the grid framework structure in the first temperature storage zone.

FIG. 15 is a magnified view of a portion of the closed network of tubing forming parallel circulation loops in the upper portion of the first temperature storage zone.

FIG. 16 is perspective side of a portion of the first temperature storage zone showing a portion of the closed network of tubing extending into the track system.

FIG. 17 is a perspective view of a portion of the closed network of tubing showing an array of parallel tubes extending through the tote guides.

FIG. 18 is a perspective view of a portion of the grid framework structure in the first temperature storage zone showing the closed network of tubing extending through the plurality of tote guides. FIG. 19 is an isometric view of the dual temperature grid framework structure showing the first temperature storage zone enclosed in cladding.

FIG. 20 is a perspective view of the first temperature storage zone with the cladding removed.

FIG. 21 is a temperature distribution plot of the environment above and below the track system demonstrating the effects of the radiant cooling system according to the present invention.

### DETAILED DESCRIPTION

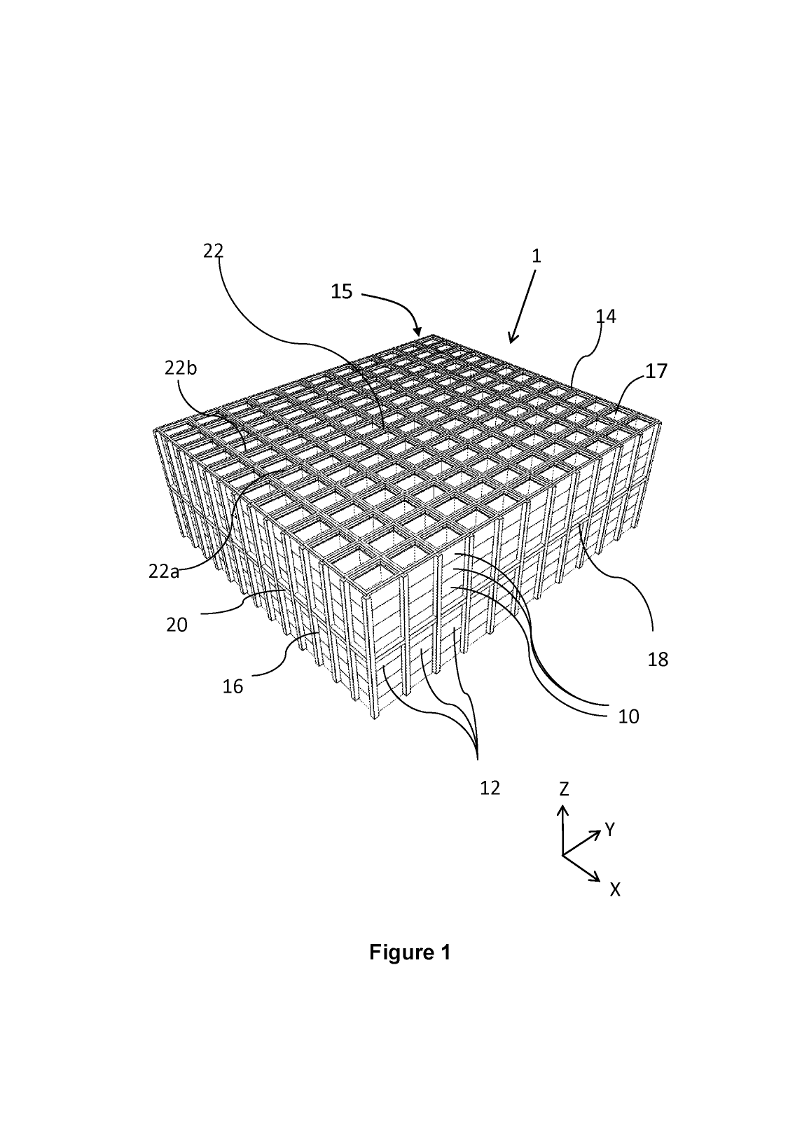

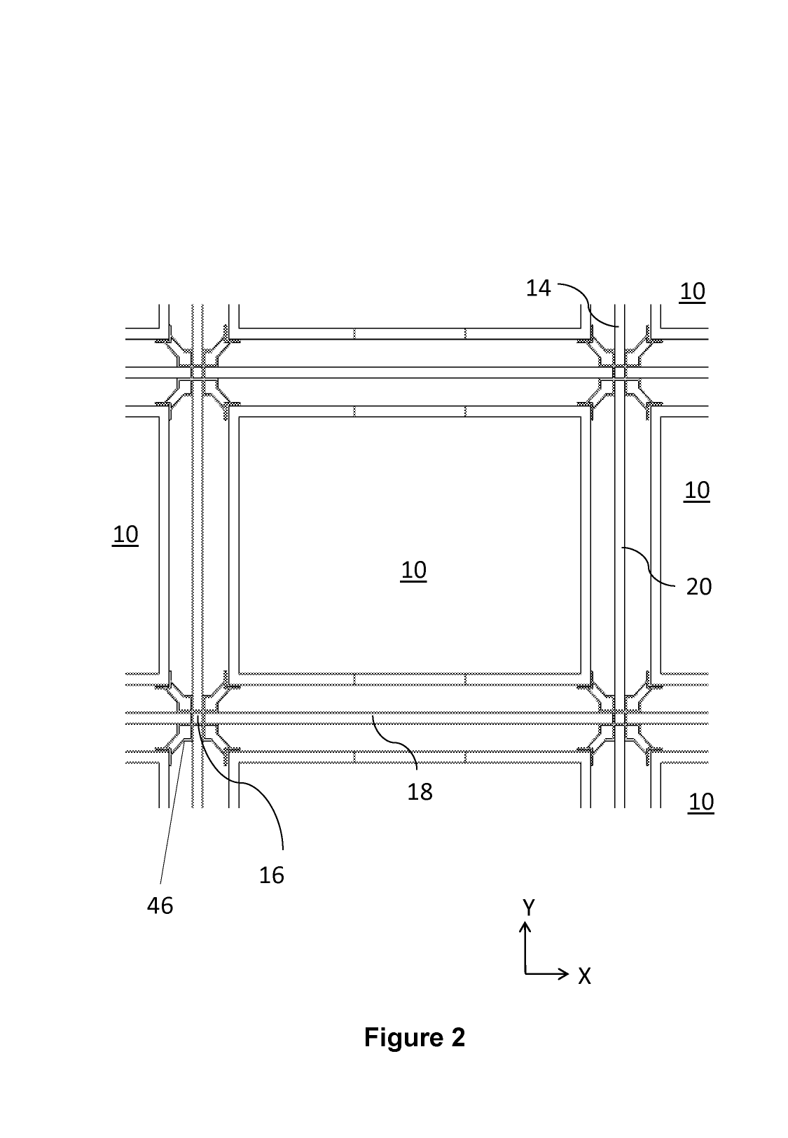

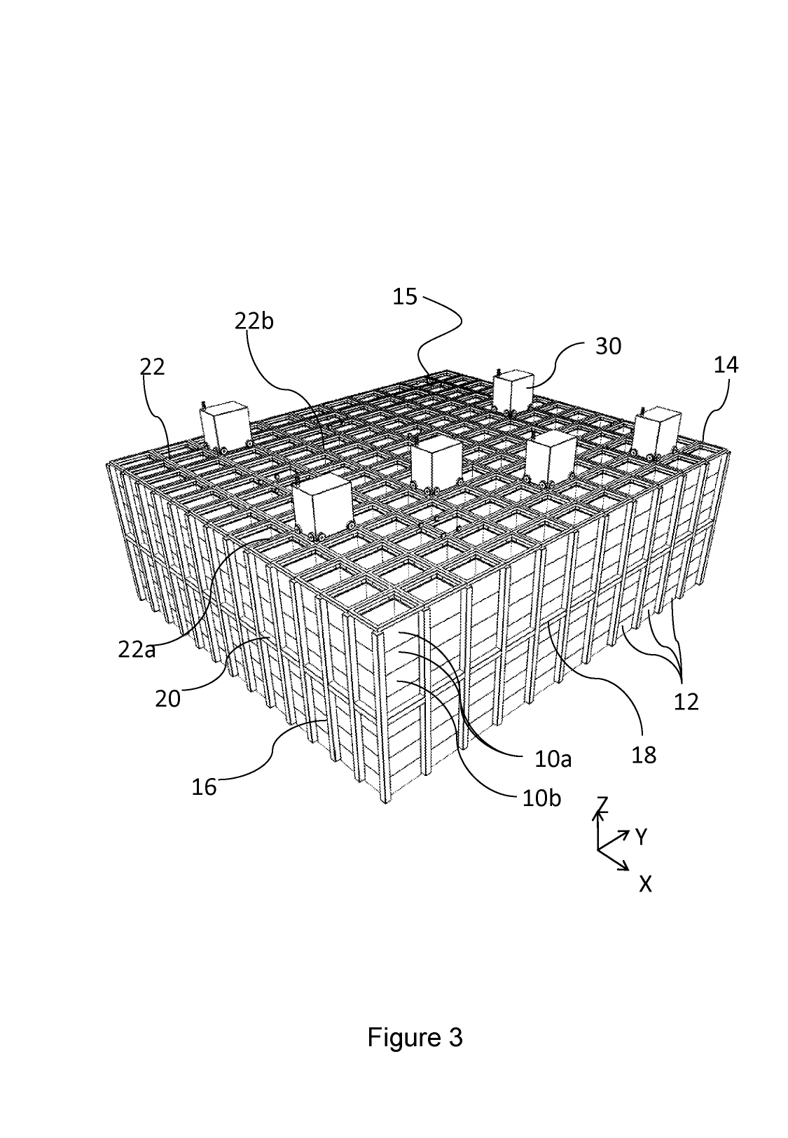

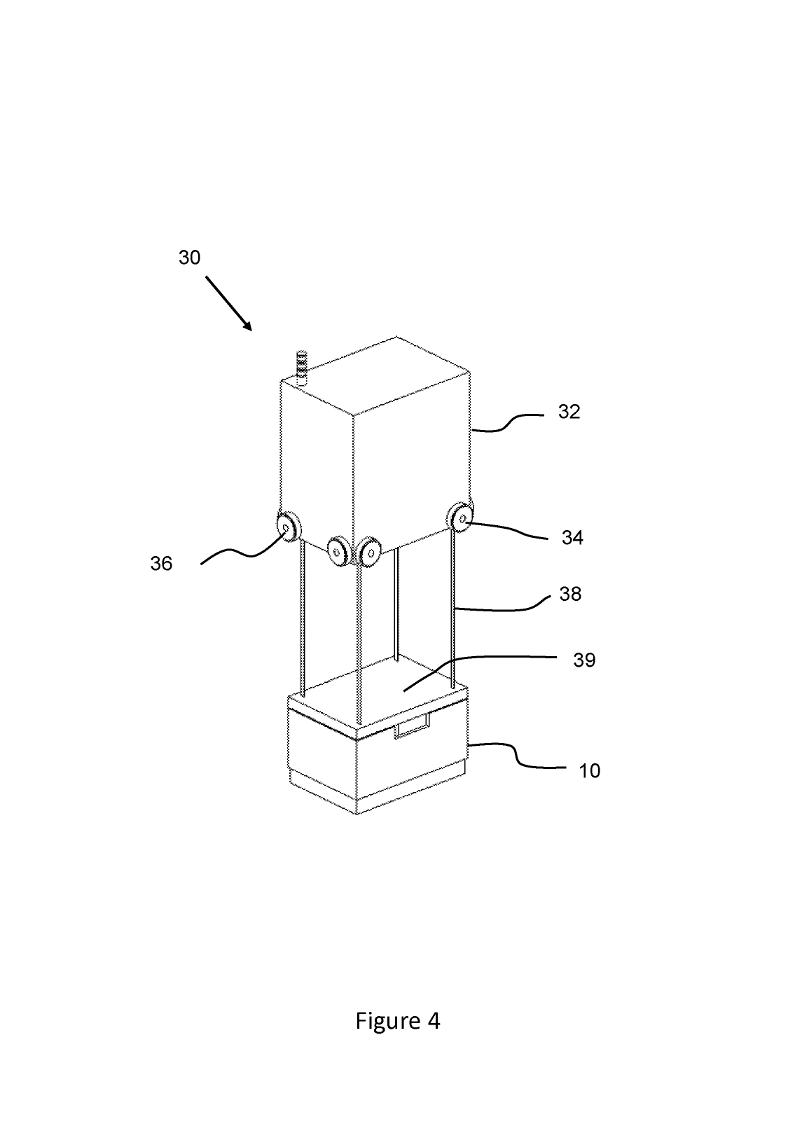

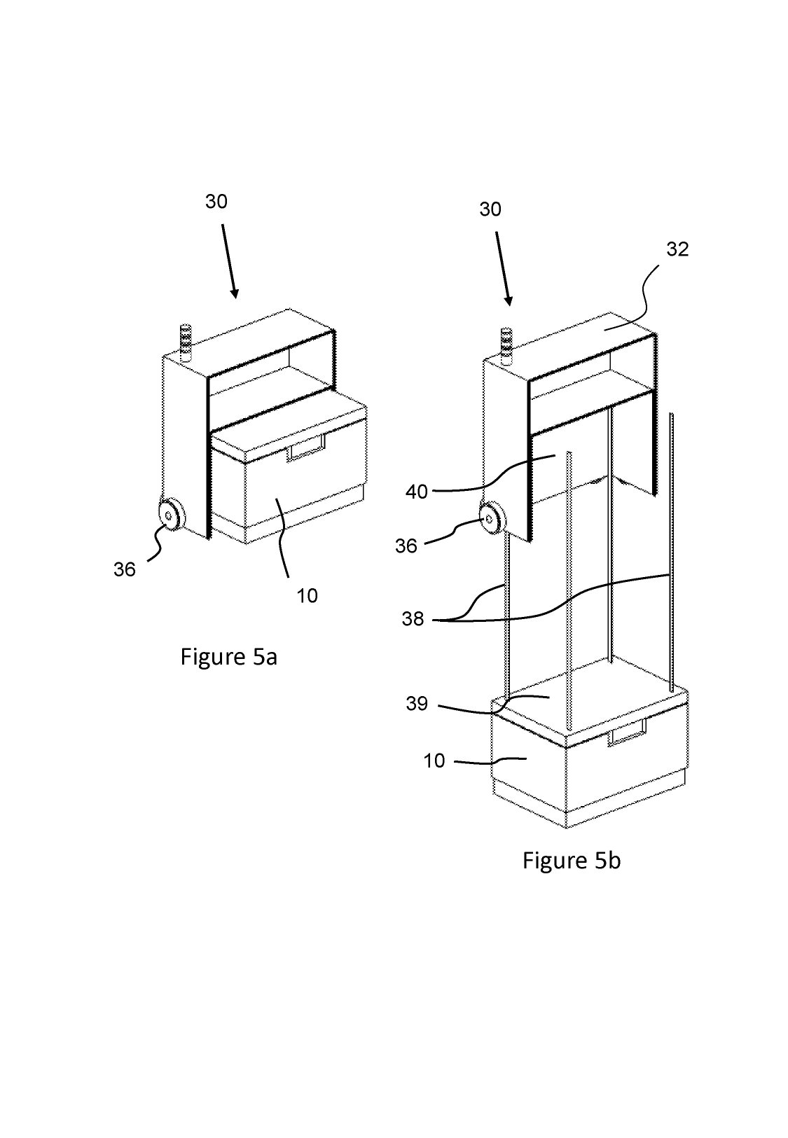

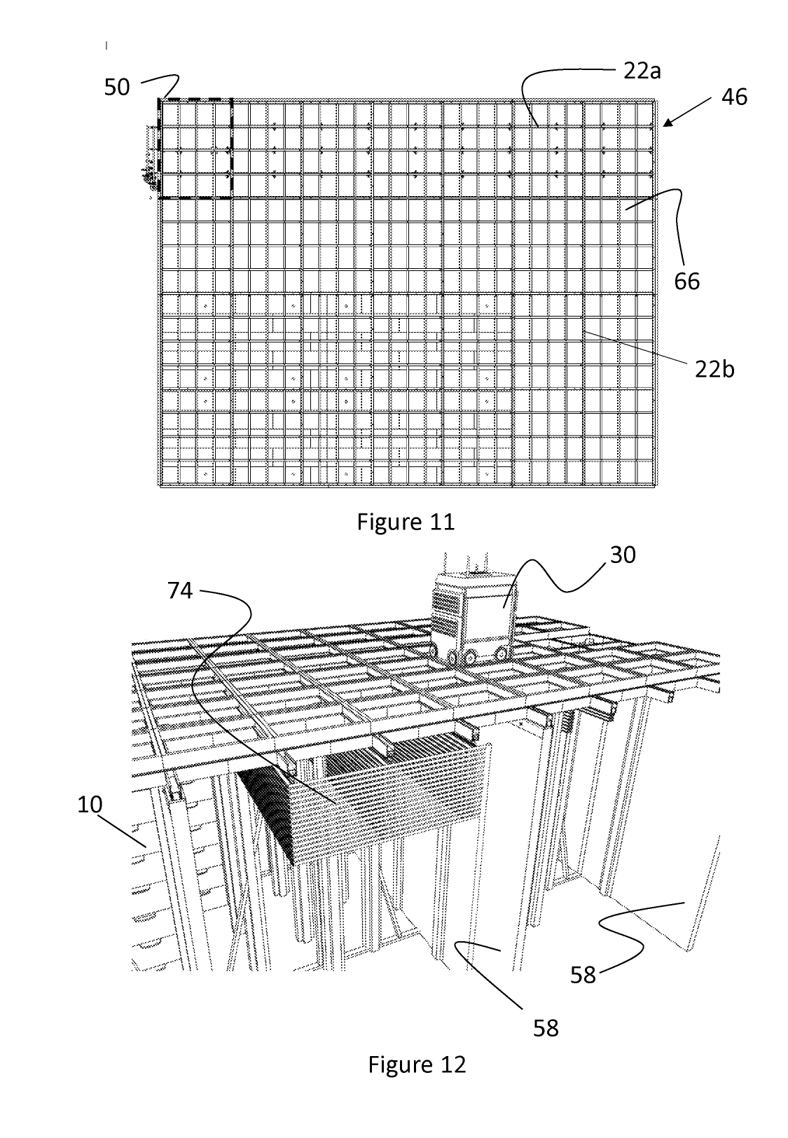

It is against the known features of the storage system such as the grid framework structure and the load handling device described above with reference to FIGS. 1 to 5(a and b), the present invention has been devised. An example of a grid framework structure 42 according to an embodiment of the present invention comprises a support framework 44 structure comprising a plurality of storage columns and a track system 46 for guiding the movement of one or more robotic load handling devices on the grid framework structure 42. In contrast to the existing grid framework structure as described in the introductory section of the description, the supporting framework structure 44 according to the present invention is erected from a plurality of supporting walls 48 arranged in a grid pattern to define a three dimensional supporting framework structure 44 comprising a plurality of modular storage cells 50 (see dashed box in FIG. 11), each of the modular storage cells 50 being sized to accommodate two or more storage columns, i.e. two or more stacks of storage containers. In the particular embodiment of the present invention, the plurality of supporting walls 48 comprises a plurality of prefabricated frames.

Prefabrication of the frames 48 involves assembling and fixing separate components of the supporting framework structure 44 together prior to erecting the supporting framework structure 44. The prefabricated frames 48 can be envisaged to be planar. This allows ease of assembly of the supporting framework structure 44 since the use of prefabricated frames 48 greatly reduces the time and effort to assemble the supporting framework structure 44 rather than erecting a plurality of vertical uprights one by one in a “stick by stick” approach and then mounting the track system to the supporting framework structure as currently practised in the art.

The prefabricated frames 48 forming the supporting framework structure according to the particular example of the present invention shown in FIG. 7 are each configured as prefabricated braced frames or panels 48 comprising a plurality of uprights 52 braced together by one or more bracing members 54, 56 extending between the plurality of uprights 52. The plurality of uprights 52 of each of the prefabricated braced frames 48 making up the supporting framework structure 44 can be braced by both horizontal 54 and diagonal bracing members 56. To enable the prefabricated braced frames 48 to be flat packed to facilitate transport, the plurality of uprights 52 of each of the prefabricated braced frames 48 extend in a common plane and are secured together by one or more of the bracing members 54, 56. The one or more bracing members connecting the plurality of uprights lie in the same plane as the plurality of the uprights such that each of the prefabricated braced frames is planar. Each upright 52 of the plurality of uprights can be a solid support beam of I-shape or H-shape or U shaped comprising opposing beam flanges or C shaped or L shaped to enable the uprights to be braced together by the one or more bracing members.

The bracing allows a sub-group of uprights 52 to be pre-assembled together prior to being assembled in the supporting framework structure 44. In the particular example shown in FIG. 7, the plurality of horizontal bracing members 54 extend between the upper and middle regions of the plurality of uprights 52. Each horizontal bracing member 54 functions as a load bearing beam extending between the uprights 52. The horizontal bracing element 54 braces at least two of the uprights 52 at their upper and/or middle regions. The horizontal bracing element 54 therefore acts as a drag strut or collector, as commonly known in the art. A drag strut or collector is a structural element (for example, a truss) installed parallel to an applied load that collects and transfers diaphragm shear forces to vertical elements, in this case the uprights 52. In addition to at least one horizontal bracing member 54 extending between the plurality of uprights 52 of each of the prefabricated brace frames 48 at least one diagonal bracing member 56 can be connected to the uprights to provide additional stability to the prefabricated braced frame. The bracing members 54, 56 extending between the plurality of uprights 52 are designed to work in tension and compression similar to a truss. The bracing between the plurality of uprights can be designed in different patterns including cross-bracing, K-bracing, V-bracing and/or eccentric bracing. Cross-bracing, also known as X-bracing, is made of two diagonal bracing members crossing each other. The bracing members in K bracing are arranged to form a K shape between the plurality of uprights. In the particular embodiment of the present invention shown in FIG. 7, the pattern of the bracing members 54, 56 connecting the plurality of uprights 52 of each of the prefabricated braced frames 48 shown in FIG. 7 adopts a K bracing pattern providing an A frame.

The bracing members 54, 56 are fixedly connected to the uprights 52 by fasteners commonly known in the art. These include but are not limited to welding, bolts, rivets, or a combination thereof. Various lightweight materials can be used in the prefabrication of the frames. These include but are not limited to metal, plastic, or a fibre reinforced composite material. To reduce cost of manufacture of the grid framework structure, each of the uprights 52 and/or the bracing members 54, 56 can be formed from a folded sheet metal blank having one or more fold lines. Examples of folding the sheet metal blank to form the upright 88 include but is not limited to cold rolling. As the grid framework structure is primarily used to store grocery items, the metal type used in the fabrication of the tote guide should be sufficiently corrosion resistant. Examples of metal types of the sheet metal blank used to form the tote guide include but is not limited to stainless steel or galvanised steel.

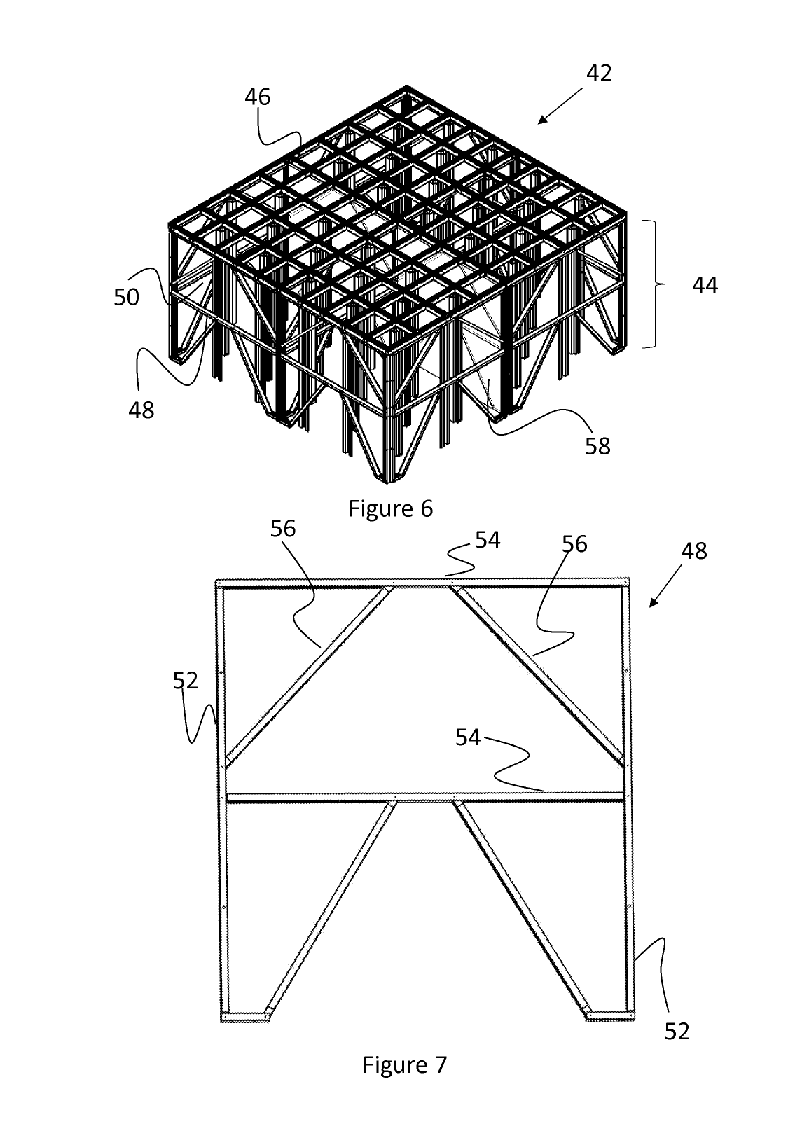

The plurality of the prefabricated frames 48 are arranged in a three dimensional grid pattern as shown in FIG. 6 in the sense that the prefabricated frames comprises a first set of parallel prefabricated frames and a second set of parallel prefabricated frames. The first set of parallel prefabricated frames extend in a first direction and the second set of parallel prefabricated frames extend in a second direction, the second direction being substantially perpendicular to the first direction such that the plurality of the prefabricated frames are arranged in a grid pattern comprising a plurality of modular storage cells or spaces 50. The first and second directions can represent X and Y axes of a Cartesian coordinate system. Each of the plurality of prefabricated frames 48 are sized such that each of the modular storage cells 50 generate storage spaces for the storage of a plurality of stacks of storage containers within the supporting framework structure, i.e. an open storage space for the storage of a plurality of stacks of storage containers.

Connection of adjacent prefabricated frames 48 in the supporting framework structure 44 involves connecting one of the plurality of uprights 52 of a prefabricated frame 48 extending in the first direction to one of the plurality of uprights 52 of an adjacent prefabricated frame 48 extending in the second direction. Various fasteners or fixtures known in the art can be used to connect adjacent prefabricated frames together. These include but are not limited to bolts, riveting, welding or even the use of a suitable adhesive.

To provide a multi-temperature storage system 57 for storing items or goods at different temperatures, at least a portion of the supporting framework structure is divided into a first temperature storage zone 60 and a second temperature storage zone 62 by at least one thermally insulating panel. To divide the supporting framework structure into a multi-temperature storage system by the at least one thermally insulating panel without encroaching on the storage capacity of grid framework structure, the at least one of the supporting walls of the supporting framework structure comprises the thermally insulating panel 58 (also termed ‘thermally solid walled panel) such that the thermally insulating panel forms at least a portion of the supporting framework structure (see FIG. 6 and 12). The at least one thermally insulating panel 58 divides the plurality of storage columns into a first group of storage columns that defines the first temperature storage zone 60 for the storage of a first group of stacks of storage containers and a second group of storage columns that defines the second temperature storage zone 62 for the storage of a second group of stacks of storage containers. For the thermally insulating solid walled panels to form part of the make-up of the supporting framework structure 44, the thermal insulating solid walled panels 58 need to be load bearing. For the thermal insulating solid walled panels to be a load bearing wall within the grid framework structure, optionally, one or more of the thermal insulating solid walled panels comprises a structural insulation panel (otherwise known as a SIP panel) comprising a thermal insulation core sandwiched between at least two layers of structural board. An example of a structural board that is load bearing includes but is not limited to magnesium oxide. In the particular embodiment of the present invention shown in FIG. 19, the first group of storage columns is contained within an enclosure 64 to define the first temperature storage zone 60, wherein each of the supporting walls of the enclosure is formed by the at least one thermally insulating panel. The enclosure 60 provides a volume within the enclosure 60 that can be temperature controlled.

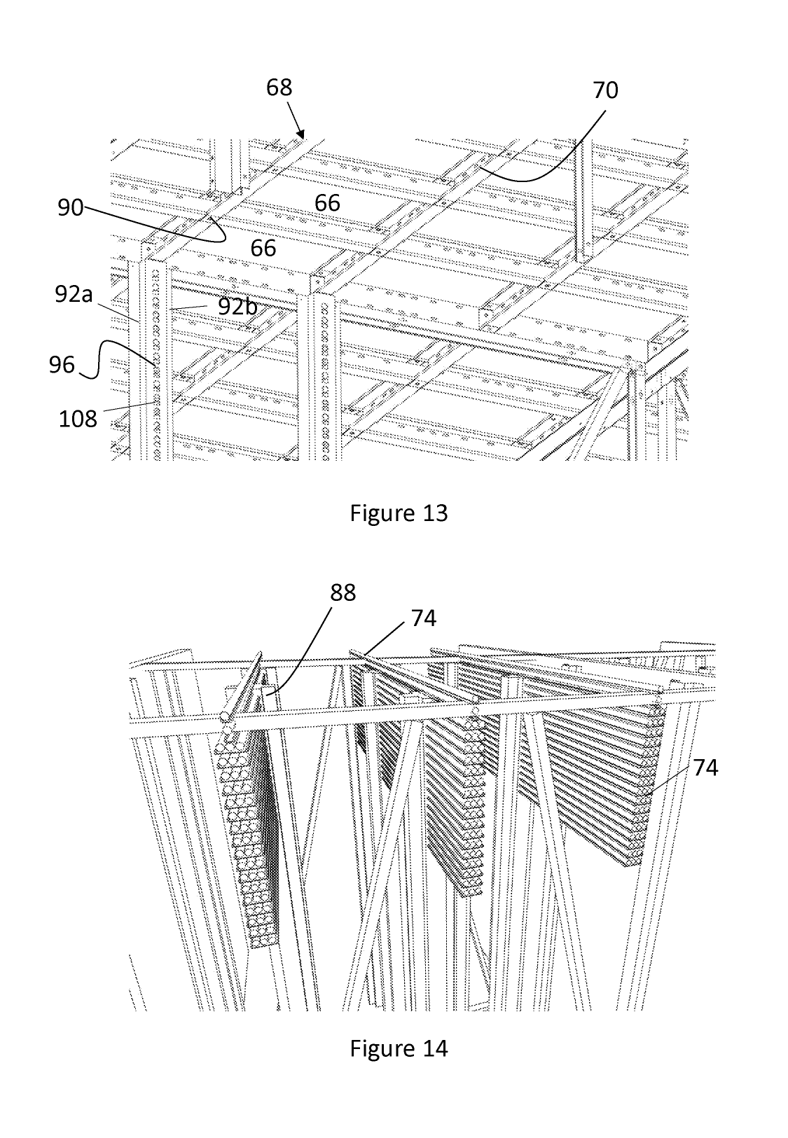

To guide one or more robotic load handling devices 30 on the grid framework structure 42, the track system 46 is mounted to the supporting framework structure 44 such that the track system 46 extends across the first temperature storage zone 60 and the second temperature storage zone 62. The track system 46 comprises a plurality of tracks arranged in a grid pattern comprising a plurality of grid cells 66 (see FIG. 11). More specifically, a first set of parallel tracks 22a extending in the first direction and a second set of parallel tracks 22b extending in the second direction, the second direction being substantially perpendicular to the first direction to adopt a grid like pattern (see FIG. 11). The track system further comprises a track support structure 68 comprising a plurality of track supports 70 arranged in a grid pattern corresponding to the grid pattern of the plurality of tracks (see FIG. 13). More specifically, the plurality of track supports comprises a first set of track support extending in the first direction and a second set of track supports extending in the second direction, the second direction being substantially perpendicular to the first direction. The plurality of tracks are mounted to the track support structure. Whilst not shown in FIG. 6, the track system 46 can be assembled from a plurality of prefabricated modular sub-track support structures, wherein each of the plurality of prefabricated modular sub-track support structures comprises a portion of the first set of grid members and a portion of the second set of grid members so providing two or more grid cells. Further detail of the track system comprising the track support structure is discussed in WO2022/034195 (Ocado Innovation Limited), the details of which are herein incorporated by reference.

As each of the plurality of modular storage cells 50 of the supporting framework structure 44 is sized to accommodate a plurality of stacks of storage containers, each modular storage cell 50 of the supporting framework structure 44 is sized to accommodate a sub-group of two or more grid cells of the track system 46. In the particular embodiment of the present invention showing a top plan view of the grid framework structure in FIG. 11, each of the plurality of the modular storage cells 50 of the supporting framework structure 82, shown as a dashed box for illustration purposes in FIG. 11, is sized to accommodate sixteen grid cells 66 of the track system 46. Thus, each of the modular storage cells 50 of the supporting framework structure 44 provides a storage space for the storage of sixteen stacks of storage containers. The size of each of the plurality of modular storage cells is not limited to accommodating sixteen grid cells of the track system 46 and can be a plurality of grid cells of the track system. In other words, the ratio of the number of grid cells 66 of the track system 46 per grid cell of the modular storage cell 50 of the supporting framework structure 82 can be equated to X: 1, where X is any integer greater than one, i.e. each of the plurality of modular storage cells 50 of the supporting framework structure 44 is sized to support a subset of the plurality of grid cells 66 of the track system 46, said subset comprising two or more grid cells 66 of the track system 46. In the particular example shown in FIG. 11, X equates to sixteen which means that the grid cells of the track system per modular storage cell is in the ratio 16:1.

The temperature inside the enclosure 64 defining the first temperature storage zone 60 is maintained at a temperature lower than the temperature outside the enclosure by a cooling system. The temperature outside of the first temperature storage zone includes the second temperature storage zone and the environment above the track system. For example, the cooling system can maintain the temperature inside the enclosure to provide a chilled zone, e.g. in the temperature range of 4°C to 8°C. Equally, the cooling system can maintain the temperature inside the enclosure to provide a freezer zone, e.g. in the temperature range -18°C to -30°C. The temperature outside of the enclosure 64 can be at ambient temperature. The ambient temperature can include the temperature of the external environment which is not regulated by the cooling system and is very dependent on the seasonal temperature which can range from 0°C in the winter months to 30°C in the summer months. The thermal insulating walls of the enclosure 64 reduces the transfer of heat through the walls of the enclosure 6 such that the temperature inside the enclosure 64 is at different to the temperature outside of the enclosure 64.

In contrast to a forced air circulation system where cool air is forcibly circulated within the first temperature storage zone by a blower, in accordance of the present invention the environment within the first temperature storage zone 60 is cooled by a radiant cooling system 72 that utilizes the principle of radiant heat transfer emitted from warmer bodies to exchange heat with a heat transfer fluid circulated within the first temperature storage zone. In comparison to a conventional cooling system based on a forced air circulation system, radiant cooling offer the benefit of reduced energy consumption since the bulk of the heat within the first temperature storage zone is removed by radiation. The warmer bodies in the first temperature storage zone can include but are not limited to storage containers and their contents. In comparison to a forced air cooling system, radiant cooling system is focused on using cooled surfaces to remove heat largely by radiant exchange and secondary by other methods such as convection. The benefit of radiant cooling over other cooling systems is that heat exchange can be concentrated to a particular region of the grid framework structure. In the present invention, radiant cooling is concentrated in the region largely below the track system 46, more particularly in the first temperature storage zone. This has the advantage of keeping the environment outside of the first temperature storage zone at the ambient temperature which will have a positive impact on the robotic load handling devices operating on the track system 46. Since the region above the track system is outside of the first temperature storage zone, the robotic load handling devices 30 operating on the track system 46 can operate at ambient temperatures. As a result, the robotic load handling devices operating on the track system will not be negatively impacted by the effects of the cooler temperatures, e.g. chilled temperatures or frozen temperatures, in the first temperature storage zone. The functionality of various components of the robotic load handling device such as the rechargeable power source, e.g. battery, and/or other electrical components may be compromised at low temperatures and in a worst case scenario function improperly.

In addition to the region below the track system being at a different temperature to the region above the track system, other areas of the supporting framework structure outside of the first temperature storage zone 60 separated by the at least one thermal insulating wall 58, namely the second temperature storage zone 62, can also provide an area for the storage of goods or items at a different temperature to the first temperature storage zone, e.g. ambient temperature. As the track system 46 extends across the first and the second temperature storage zones 60, 62, one or more robotic load handling devices operating on the track system are able to access storage containers stored at different temperatures from the first temperature storage zone and the second temperature storage zone respectively without the need to be exposed to the cooler temperatures in the first temperature storage zone.

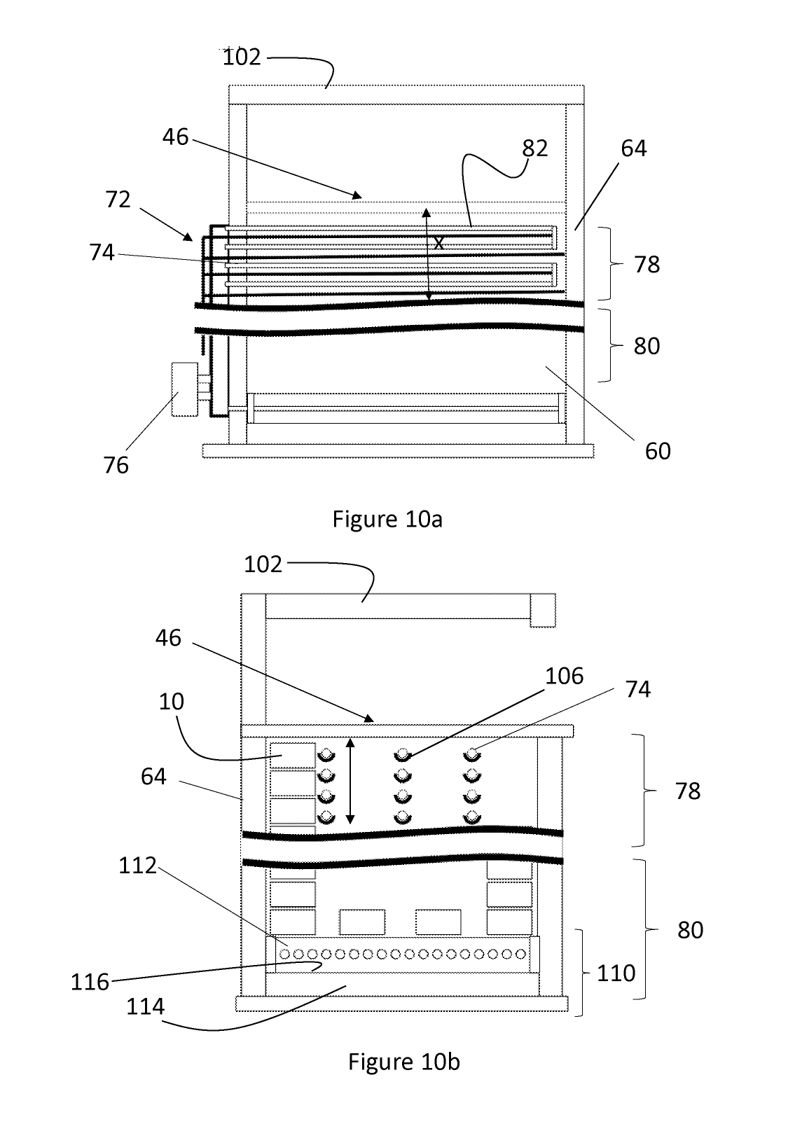

In the particular embodiment of the present invention shown in FIGS. 9 and 10(a and b), the cooled surfaces to exchange heat radiated from bodies in the first temperature storage zone 60 is provided by a closed network of tubing or pipes 74 carrying a heat transfer fluid in fluid communication with a cooling unit 76 extending through the first temperature storage zone 60. The heat transfer fluid can be a gas or a liquid and is maintained at a temperature below the surrounding temperature in the first temperature storage zone by exchanging heat with the cooling unit 76. The cooling unit 76 can be a refrigeration unit comprising a compressor, a condenser, an expansion valve and an evaporator (metering device). The heat transfer fluid can be a refrigerant, e.g. comprising glycol. The closed network of tubing 74 distributes the heat transfer fluid within at least a portion of the first temperature storage zone 60. Heat absorbed by the heat transfer fluid within the first temperature storage zone is exchanged by the cooling unit or refrigeration unit 76.

As hot air rises through convection and cool air descends towards the bottom of the supporting framework structure, at least a portion of the closed network of tubing 74 is concentrated in the upper portion 78 of the first temperature storage zone 60. By concentrating the at least portion of the closed network of tubing 74 in the upper portion 78 of the first temperature storage zone 60 increases the effectiveness of the radiant cooling system to cool the environment within the first temperature storage zone. Thus, heat from warm air in the upper portion of the first temperature zone is absorbed by the network of tubing carrying the heat transfer fluid.

The ability of the heat transfer fluid to exchange heat with the surrounding environment in the first temperature storage zone 60 is very much dependent on the surface area exposure of the heat transfer fluid with the surrounding environment. The greater the surface area of exposure of the heat transfer fluid to the surrounding environment, the greater is the ability of the radiant cooling system to absorb the heat and lower the temperature in the upper portion of the first temperature storage zone. As cold air descends towards the lower portion of the first temperature storage zone, the temperature within the first temperature storage zone can be maintained at a predetermined storage temperature by the radiant cooling system in the upper portion of the first temperature storage zone, e.g. chilled or ambient temperature. The lower portion 80 of the first temperature storage zone represents the region above the floor upon which the grid framework structure rests.

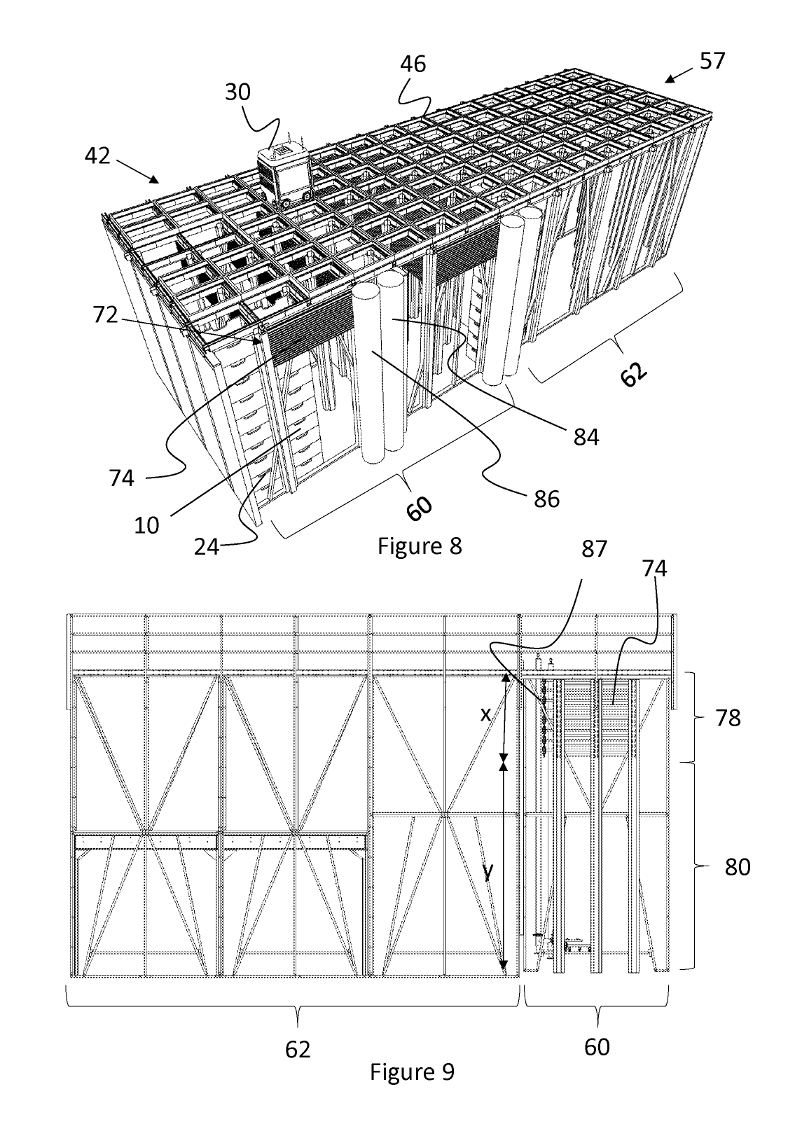

In the particular embodiment of the present invention, the at least portion of the closed network of tubing 74 within the first temperature storage zone comprises a plurality of parallel tubes 82 extending substantially horizontally in the first temperature storage zone. The plurality of parallel tubes carrying the heat transfer fluid shown in FIG. 8 and 10(a and b) are arranged to lie in a vertical plane. The depth, X, of the parallel tubes in the vertical plane corresponds to the height of the upper proportion 78 of the first temperature storage zone 60. The greater the depth, x, of the parallel tubes 82, the greater is the height of the upper portion of the first temperature storage zone of the supporting framework structure and the more effective is the ability of the heat transfer fluid to exchange heat with the surrounding environment in the first temperature storage zone, and vice versa. In comparison to the upper portion of the first temperature storage zone being occupied by the plurality of parallel tubes carrying the heat transfer fluid, the lower portion 80 of the first temperature storage zone, Y, is substantially free of parallel tubes. This is because the bulk of the heat is in the upper portion 78 of the first temperature storage zone. The relationship between the height of the upper and lower portion of the first temperature storage zone can be equated by the ratio 1: Y, where Y is the height of the lower portion of the first temperature storage zone. For example, where Y equates to 1, the ratio of the height of the upper portion occupying the parallel tubes and the lower portion is 1:1. Depending on the temperature of the ambient temperature outside of the first temperature storage zone, Y can range from 1 to 10, where Y equal to 10 would mean that the height of the upper portion comprising the at least portion of closed network of tubing carrying the heat transfer fluid would represent a smaller portion of the height of the supporting framework structure.

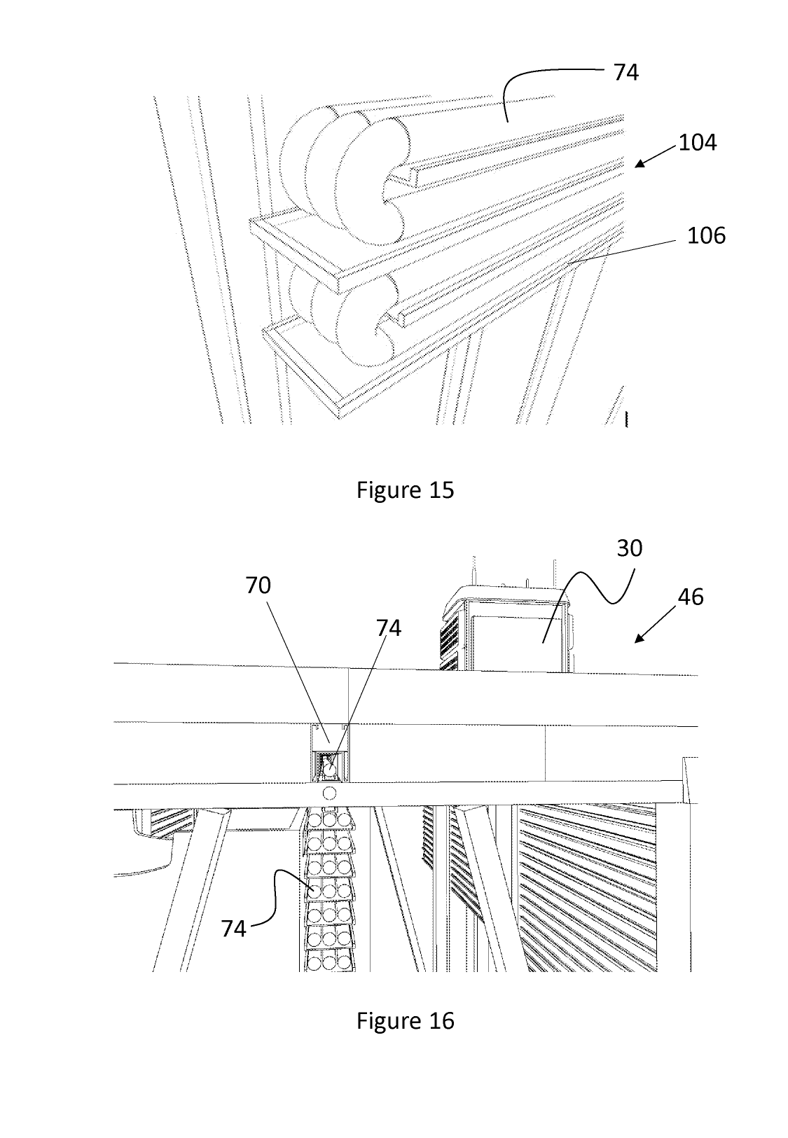

The parallel tubes 82 in the upper portion of the first temperature storage zone are sufficiently spaced apart to allow air to circulate between the tubes and exchange heat with the heat transfer fluid carried by the tubes. The heat transfer fluid is distributed through the network of parallel tubes at a supply pressure by at least one distribution system 84 in cooperation with the cooling unit to exchange heat absorbed by the heat transfer fluid distributed within the upper portion of the first temperature storage zone. In the particular embodiment of the present invention, the at least one distribution system 84 is common to the network of parallel tubing extending in the upper portion of the first temperature storage zone in the sense that the heat transfer fluid is supplied to the network of parallel tubing by the at least one distribution system. Heat transfer fluid distributed to the network of parallel tubing is re-circulated back to the cooling unit 76 where heat absorbed by the heat transfer fluid in the first temperature storage zone is exchanged by the cooling unit. In addition to the at least one distribution system 84 for distributing the heat transfer fluid at a given supply pressure to the network of tubing extending in the upper portion of the first temperature storage zone, the heat transfer fluid is re-circulated back to the cooling unit by at least one return system 86. As a result, the network of parallel tubes extending from the at least one distribution system 84 and returning back to the cooling unit 76 via the at least return system 86 form one or more parallel circulation loops (see FIG. 15). Each of the one or more parallel loops extends from the at least one distribution system 84 to the at least one return system 86. The at least one distribution system and the at least one return system can be separate systems or an integrated system. In the particular embodiment of the present invention, the at least one distribution system and the at least one return system are separate systems that are used to distribute the heat transfer fluid to and/or from the cooling unit.

In the particular embodiment of the present invention shown in FIG. 8, each of the at least one distribution system and the at least return system comprises one or more manifolds. To differentiate between the manifold forming the at least one distribution system and the manifold forming the at least one return system, the manifolds are termed distribution manifold 84 and return manifold 86, respectively. Thus, the network of parallel tubes branch out from the distribution manifold 84 to the return manifold 86 forming the one or more parallel circulation loops. The parallel circulation loops extend into the first temperature storage zone for exchanging heat with the surrounding environment in the first temperature storage zone. The distribution manifold and the return manifold are shown in FIG. 8vertically extending along at least a portion of the height of the grid framework structure.

The cooling capacity of the radiant cooling system to exchange heat with the surrounding environment in the first temperature storage zone is very dependent on the density of the tubes carrying the heat transfer fluid in the first temperature storage zone. To maximise the cooling capacity of the radiant cooling system, a plurality of parallel circulation loops extends between two or more storage columns as shown in FIG. 10b and 14. In another extreme, the parallel circulation loops can extend around the outer periphery of the first temperature storage zone so as to heat exchange around the outer periphery of the first temperature storage zone as shown in FIG. 12.

For maximum cooling capacity, each storage column in the first temperature storage zone is adjacent to a plurality of parallel circulation loops so as to exchange heat with the surrounding environment in the storage column. However, the present invention is not limited to the plurality of parallel circulation loops being adjacent each of the storage columns in the first temperature storage zone. The plurality of parallel circulation loops can be distributed between any numbers of the storage columns in the first temperature storage zone. For example, the plurality of parallel circulation loops can be distributed in the first temperature storage zone such that one or more storage columns extends between a pair of parallel circulation loops. In the particular embodiment shown in FIG. 10b and in the cross-sectional view shown in FIG. 14, the parallel circulation loops can be arranged such that there is a single wall of tubes extending horizontally between the storage columns. To further increase the cooling capacity of the radiant cooling system, the parallel circulation loops extending horizontally through the first temperature storage zone can be arranged such that there is an array of tubes extending horizontally between two or more storage columns. In the particular embodiment shown in FIG. 14, the parallel circulation loops are arranged such that there is an array of 3 by 17 tubes extending between two or more storage columns. However, the array of tubes carrying the heat transfer fluid can be any number of parallel circulation loops extending between the storage columns.

To control the flow of the heat transfer fluid within the at least portion of the closed network of tubing extending in the first temperature storage zone, the at least one common distribution system can comprise at least one control valve 87 to control the flow of the heat transfer fluid to one or more of the plurality of substantially parallel tubes. Thus, the cooling capacity within the upper portion of the first temperature storage zone can be controlled by controlling the flow of heat transfer fluid within one or more of the plurality of parallel tubes. In the particular embodiment shown in FIG. 9, the flow of heat transferred fluid is controlled to each of the plurality of parallel circulation loops from the at least one distribution system by the at least one control valve. However, the present invention is not limited to each of the parallel circulation loops comprising a control valve and the at least one control valve can control the heat transfer fluid to a sub-group of the plurality of parallel circulation loops. For maximum cooling capacity, in particular in the summer months, the heat transfer fluid is set up to flow through all of the plurality of parallel circulation loops. In the winter months, for example, where the external ambient temperature is low, one or more of the parallel circulation loops can be switched off to reduce the cooling effect of the radiant cooling system, i.e. a reduced number of parallel circulation loops carrying the heat transfer fluid. The number of parallel circulation loops extending horizontally between the storage columns is very much limited on the availability of space between the storage columns without encroaching on the storage capacity of the grid framework structure as a whole. As the load bearing capacity of the grid framework structure is largely taken up by the supporting framework structure 44 comprising a plurality of prefabricated frames 48 and at least one thermally insulating panel 58, the plurality of parallel circulation loops can extend through a plurality of tote guides 88 for guiding the storage container along a given storage column. This is because the weight of the track system and one or more robotic load handling devices operable on the track system is supported by the prefabricated frames 48 and the at least one thermally insulating panel 58 arranged to form the supporting framework structure 44 discussed above. The plurality of tote guides 88 extend from one or more nodes 90 (see FIG. 13) where the plurality of tracks intersect in the track system to the floor such that the storage containers are guided along the tote guides and through a grid cell of the track system. The plurality of the tote guides are arranged in each of the modular storage cells 50 of the supporting framework structure to form a plurality of storage columns for the storage of a plurality of stacks of storage containers within each of the plurality of the modular storage cells.

The tote guides 88 can be secured to the track support structure 68 at the nodes of the track system 46 by a cap (not shown) mounted to the uppermost portion of the tote guide 88 and comprising one or more bolts and/or pins. The cap comprises at least one locating pin that is received within an opening in the underside of the track support structure 68 where the track supports 70 intersect at the nodes 90 in the track system 46. The lowermost portion of the tote guide 88 is secured to the floor by one or more anchoring bolts (not shown). The tote guides are secured within the modular storage cells by tensioning the tote guides between the floor and the track system. The cap can optionally comprise a tension bolt (not shown) for tensioning the tote guide between the track system and the floor.

To guide one or more storage containers along a given storage column, each tote guide of the plurality of tote guides comprises two perpendicular bin guiding plates 92(a and b) extending between the track system and the floor for accommodating a corner of a storage container (see FIG. 13). The two perpendicular bin guiding plates are configured to accommodate a corner section of a grabber device and/or storage container. For maximum stability of the storage containers as they are guided along the storage columns, four tote guides for a given storage column would be necessary to accommodate the four corner sections of a standard storage container, which is generally rectilinear in shape. However, it is not necessary to engage or accommodate all four corners of a storage container along the tote guides as the container is hoisted towards the track system by the lifting mechanism of the load handling device. In another embodiment of the present invention, the plurality of tote guides are arranged for guiding one or more containers in a stack along only a pair of diagonally opposed corners of the one or more containers. This gives the grabber device and/or the storage containers a level of lateral stability in the X and Y direction as the storage container is hoisted along diagonally opposed guides. By guiding the grabber device and/or the storage container attached thereto by only diagonally opposed tote guides, the number of tote guides necessary to guide the grabber device and/or the storage container attached thereto is reduced. In fact, the plurality of tote guides can be arranged at alternate nodes 90 in the first direction (e.g. X direction) and in the second direction (e.g. Y direction), the second direction being substantially perpendicular to the first direction, such that the one or more containers are guided along their diagonally opposed corners.

As it is not necessary for each of the plurality of tote guides to be load bearing, lower cost manufacturing methods can be used to fabricate the tote guides 88. Optionally, the plurality of tote guides are formed from a sheet metal blank folded along parallel fold lines and extend longitudinally along the sheet metal blank to form two substantially perpendicular bin guiding plates defining two tote guides. The sheet metal blank is folded along the fold lines to form two substantially perpendicular bin guiding plates defining two tote guides. The folded sheet metal blank is shown in FIG. 13 having a substantially rectangular cross-sectional centre portion 94 and a flange or lip projecting either side of the centre portion 94 that cooperate with the walls of the centre portion 94 to define the two tote guides. Another way of describing the forming process of the tote guides is to form a substantially rectangular corrugation 94 in the sheet metal blank. An example of a forming process in the manufacture of the tote guides from a folded sheet metal blank is cold rolling. As the grid framework structure is primarily used to store grocery items, the metal type used in the fabrication of the tote guide should be sufficiently corrosion resistant. Examples of metal types of the sheet metal blank used to form the tote guide include but are not limited to stainless steel or galvanised steel. The cap for securing the tote guide to the track support structure can optionally be secured to the uppermost portion of the folded sheet metal blank of the tote guide by a snap fit or optionally welded to the uppermost portion of the folded sheet metal blank. Like the tote guides, the cap (not shown) can optionally be formed from a folded sheet metal blank along a plurality of fold lines.

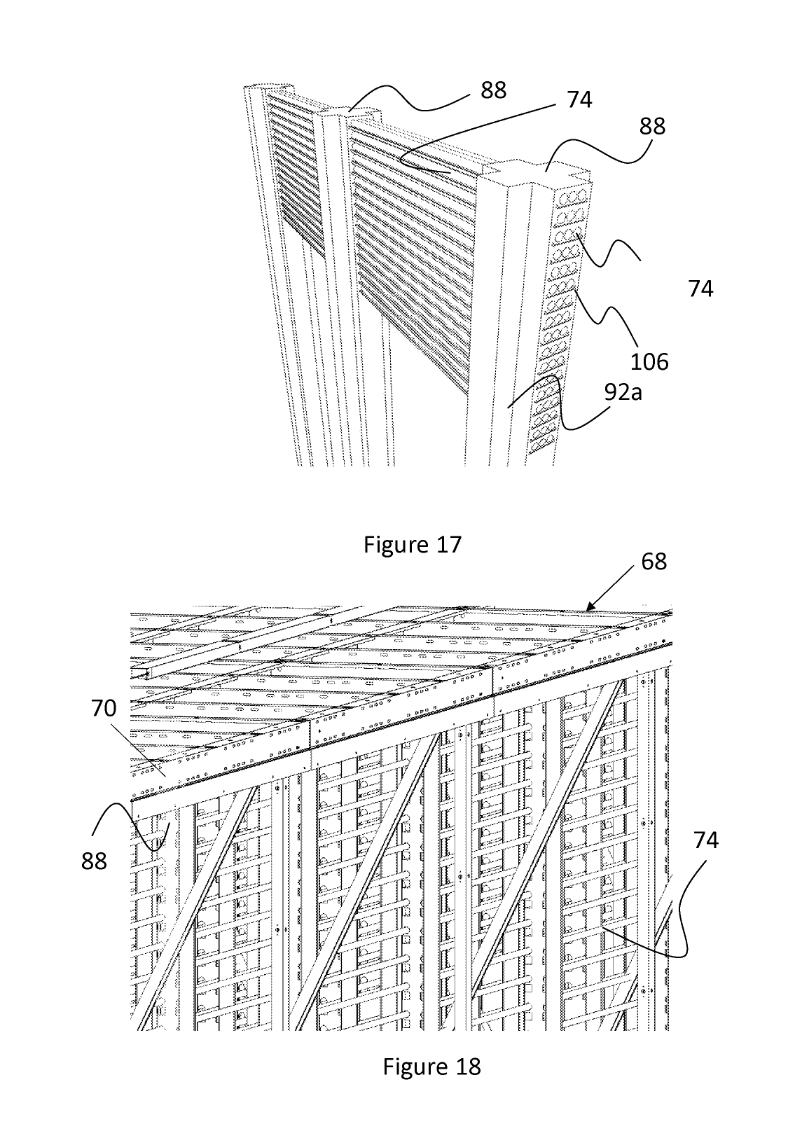

The plurality of parallel tubes extend through a plurality of holes or openings 96 formed in the plurality of tote guides 88 (as shown in FIG. 18). As shown in FIG. 13, a plurality of holes or openings 96 are cut out in the sheet metal blank used to fabricate the tote guides 88. Whilst this weakens the structural integrity of the tote guides, as discussed above, the load bearing capacity of the grid framework structure is largely borne by the prefabricated frames and the at least one thermally insulating panel. Not only does the plurality of holes in the tote guides allow the plurality of parallel tubes carrying the heat transfer fluid to be extended through the plurality of tote guides but the plurality of holes also provide support to the parallel tubing in a spaced apart relationship. Whilst the pattern of holes in the tote guides are arranged such that the plurality of parallel tubes form multiple single walled tubes between the storage columns, the present invention is not limited to having multiple single walled tubes extending between the storage columns. As discussed above, to increase the cooling capacity of the radiant cooling system, the pattern of holes in the tote guides can be arranged to accommodate an array of tubes of tubes through the plurality of tote guides as shown in FIG. 17. Any number of tubes can extend through the tote guides as the structural integrity of the grid framework structure is not dictated by the tote guides as in the traditional stick build process discussed above but largely by the supporting framework structure 44.

As the plurality of grid cells 66 of the track system 46 are open to the plurality of storage columns below so as to enable a robotic load handling device 30 operable on the track system to lower and retrieve storage containers in storage in the storage columns via the grid cells, heat from above the track system can enter the first temperature storage zone via the grid cells. Without any suitable cooling in the uppermost portion of the grid framework structure, there is a risk that air entering the uppermost portion of the grid framework structure exchange will displace the cool air in the first temperature storage zone causing warming in the region around the uppermost portion of the grid framework structure. This is exacerbated by the action of lowering a storage container through a grid cell forcing ambient air above the track system into the first temperature storage zone. To mitigate the effect of heat entering the uppermost portion of the grid framework structure via one or more grid cells and displacing the cool air, the radiant cooling system, more specifically, the closed network of tubing carrying the heat transfer fluid also extends into the track system. As shown in FIGS. 14 and 16, tubing 74 carrying the heat transfer extends into one or more track supports 70 of the track system 46. The track supports are shown as hollow or tubular members for accommodating the one or more tubes 74 of the closed network of tubing. To differentiate between the portion of the closed network of tubing extending in the first temperature storage zone, the portion of the closed network of tubing extending in the track system can be defined as the second portion of the closed network of tubing 100; the portion of the closed network of tubing extending in the first temperature zone can be defined as the first portion of the closed network of tubing 98. As a result, the upper portion of the first temperature storage zone of the radiant cooling system extends into the track system. Having the closed network of tubing extending into the track system helps to keep the region around the grid cells cool by absorbing heat radiated from the region around the grid cells. Thus, heat entering the first temperature storage zone via the grid cells is absorbed by the closed network of tubing carrying the heat transfer fluid in the uppermost portion of the first temperature storage zone which also includes the tubing extending in the track system.

To further mitigate excessive heat being generated in the region above the track system, the environment above the track system can optionally be shielded by a thermally insulating roof 102 as systematically shown in FIGS. 10(a and b)). The roof is sufficiently spaced apart from the track system 46 so as to enable the one or more robotic load handling devices to move on the track system. The roof provides shading or screening from the heat effect of direct sunlight onto the tracks.

One of the limiting factors to cooling the first temperature storage zone by radiant cooling is the risk of moisture in the air condensing on the cooled surfaces. As the heat transfer fluid carried by the network of tubing is at a much lower temperature than the surrounding air in the first temperature storage zone, there is the potential that moisture in the air will condense on the surface of the tubes. This is particularly the case if the temperature of the heat transfer fluid is at a lower temperature than the dew point temperature of the surrounding air in the first temperature storage zone. The higher the humidity of the air in the region around the network of tubing, the higher the dew point of the air and thus the greater the risk of condensation on the network of tubing extending in the first temperature storage zone. Without any means to take the water condensed on the network of tubes away, there is a risk that water accumulated on the tubes can drip into the storage containers in storage in the grid framework structure with the consequential effect of contaminating the contents of the storage containers.

In one exemplary embodiment of the present invention, water accumulated on the surface of the network of tubing is taken away from the first temperature storage zone to a region outside of the grid framework structure by a run-off system 104 comprising a network of gutters 106. In the particular embodiment of the present invention shown in FIG. 15, the network of gutters 106 extends substantially longitudinally along a portion of the parallel circulation loops 74 for capturing water condensed on the parallel circulation loops. The network of gutters can be arranged to extend below each of the plurality of circulation loops as shown in FIG. 106 or a sub-group of the plurality of circulation loops as shown in FIG. 15. As shown in FIGS. 10b and 15, each of the network of gutters has a U-shaped cross-section extending below the network of tubing 74 for capturing water accumulated on the surface of network of tubing. The network of guttering is downwardly inclined towards one or more downpipes (not shown) having an inlet opening for the water to flow into the downpipe and an outlet opening external of the grid framework structure for releasing the water externally of the grid framework structure. One or more of the downpipes extends vertically along at least portion of the height of the grid framework structure for taking away water captured from the network of gutters 106. To reduce the risk of water overfilling one or more gutters of the network of gutters, a pump (not shown) can be optionally installed to the run-off system to increase the flow rate of water through the downpipes. For example, a pump can be fitted to the outlet opening of the downpipe to increase the flowrate of water through the one or more of the downpipes. As with the plurality of parallel tubes 74, the network of gutters 106 can extend through the plurality of tote guides discussed above (see FIG. 17). In addition to having a plurality of holes 96 for threading the parallel tubes through, the tote guides can be formed with additional holes or apertures 108 for supporting the network of gutters extending through the plurality of tote guides. Each of the network of gutters extends below one or more of the plurality of parallel tubes. One or more brackets (not shown) can be used to secure the network of gutters to the plurality of parallel tubes extending in the first temperature storage zone. To control the environment in the first temperature storage zone, additionally or alternatively, the relative humidity in the first temperature storage zone can be controlled by a dehumidifier such that the dew point of the environment in the first temperature storage zone is less than or substantially equal to the temperature of the heat transfer fluid, more specifically, the temperature of the plurality of tubing. The dehumidifier can control the relative humidity of the environment in the first temperature storage zone so as to prevent excessive condensation on the plurality of tubing.

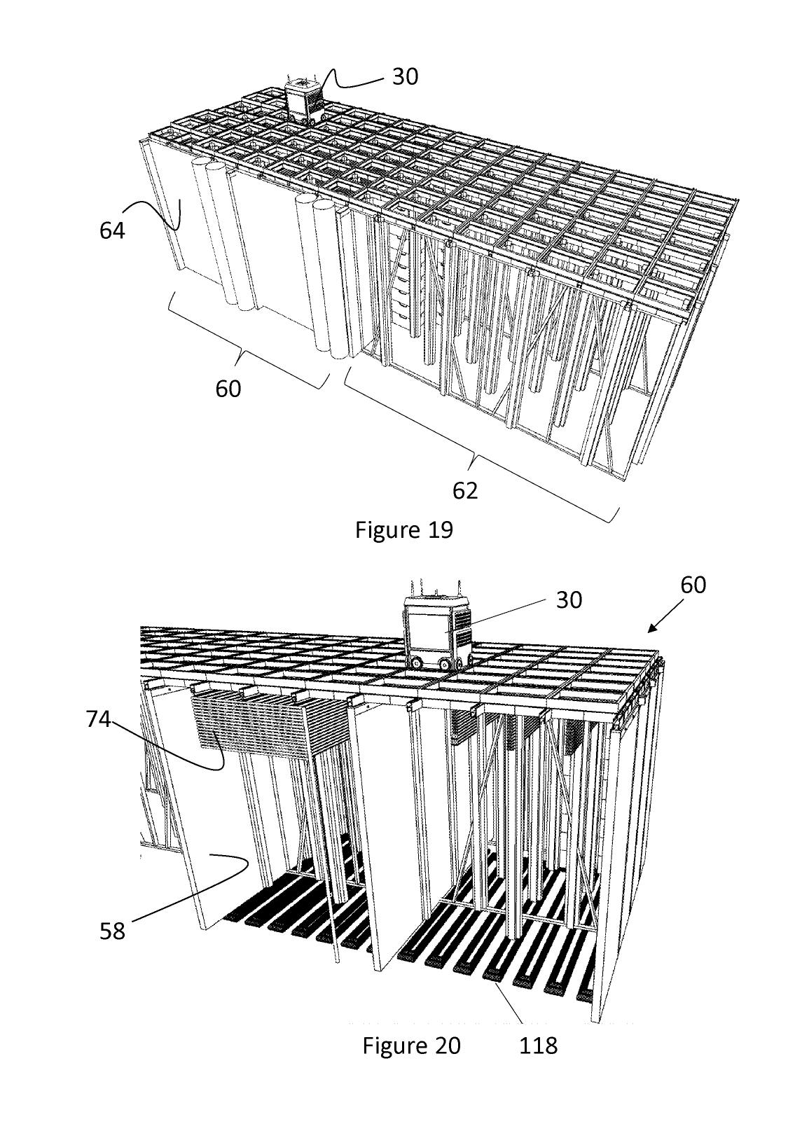

In addition to heat entering the first temperature storage zone through the grid cells, there is also the risk of heat being radiated from the floor. As the floor is a large thermal mass, heat transfer of the heat radiated from the floor by the network of tubing carrying the heat transfer fluid would take a very long time; if ever. Thus, any heat radiated from the floor may have an impact on the temperature of the contents of the storage containers in storage in the first temperature storage zone, particularly in the lower portion of the first temperature storage zone. If the first temperature storage zone is destined for the storage of goods at chilled or freezer temperatures, then the heat radiated from the floor may spoil the contents of the storage containers, particularly if the temperature of the goods rises above 8°C for chilled goods or above -18°C for frozen goods for any length of time. As the floor upon which the grid framework structure rests is a large thermal mass, to mitigate heat from the floor having an impact on the temperature of the environment within the first temperature storage zone, at least a portion of the closed network of tubing carrying the heat transfer fluid extends into the floor so as to maintain the floor at a predetermined temperature (see FIGS. 10b and 20).

As the floor 110 is a large thermal mass and would overwhelm the cooling unit, the at least portion of the closed network of tubing extends into a screed 112 placed on top of a subfloor 114 (see FIG. 10b); the screed 112 and the subfloor 114 forming the floor 110. The screed is insulated from the subfloor by a layer of insulation or a damp proof membrane 116. Examples of insulation separating the subfloor and the screed include but are not limited to polystyrene, polyurethane, mineral fibre etc. Consisting largely of gypsum, the at least portion of the closed network of tubing extends through the screed 112 and maintains the temperature of the screed at a predetermined temperature so as not to increase the temperature of the environment within the first temperature storage zone. As opposed to heat radiating from the floor into the first temperature storage zone, there is a transfer of heat from the first temperature storage zone into the floor where it is absorbed by the at least portion of the closed network of tubing extending through the screed. To differentiate from the second portion of the closed network of tubing 74 extending through the track system, the at least portion of the closed network of tubing extending in the screed can be defined as a third portion of the closed network of tubing 118. In the particular example shown in FIG. 20, the third portion of the closed network of tubing 118 are arranged in a serpentine pattern in the screed 112 but other patterns for distributing the heat transfer fluid in the screed are applicable in the present invention. As a result, the closed network of tubing 74 carrying the heat transfer fluid extends in the upper portion of the first temperature storage zone 78 and in the floor 110 below the first temperature storage zone via the screed, i.e. below the lower portion of the first temperature storage zone. By maintaining the temperature of the screed at a predetermined temperature, the delta temperature (δT) between the temperature of the screed and the temperature of the environment in the first temperature storage zone can be reduced to a minimum. Consequently, the efficiency of the cooling unit to exchange heat with the transfer fluid is improved and the ability of the radiant cooling system to effectively maintain the temperature of the environment within the first temperature storage zone at the chilled temperature or the frozen temperature is greatly improved.

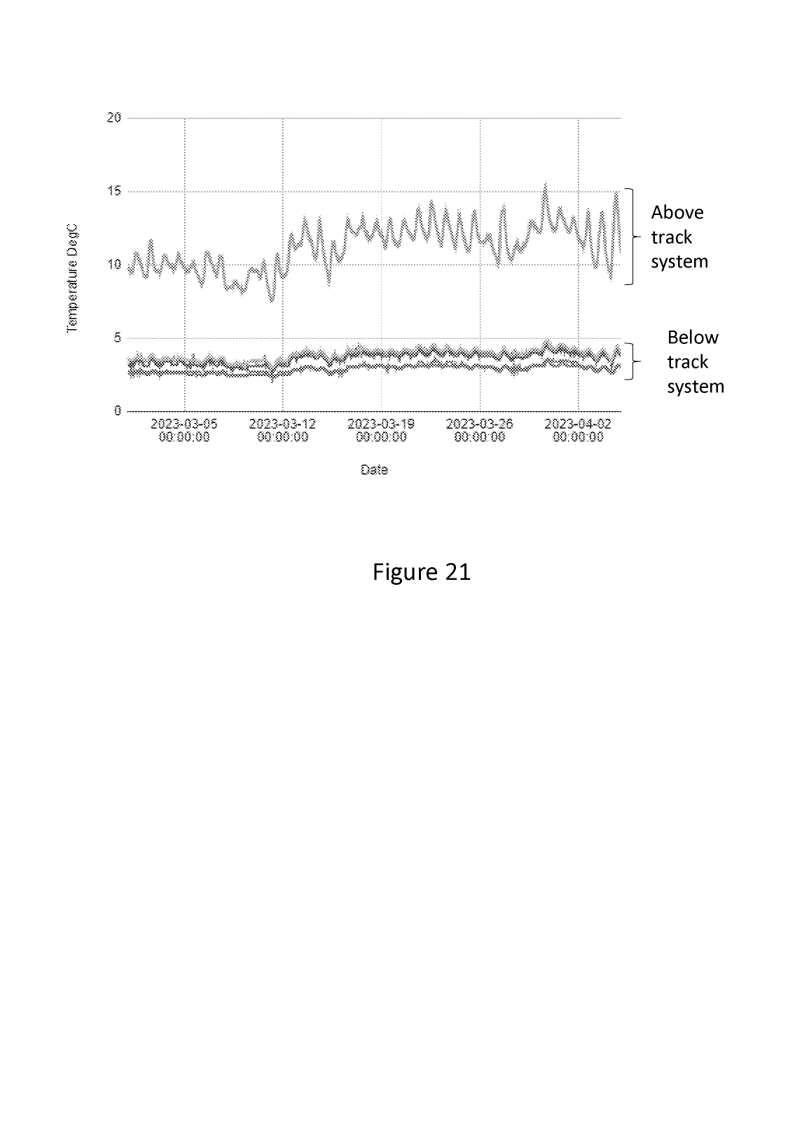

The effectiveness of the radiant cooling system to maintain the temperature within the first temperature storage zone at the chilled temperature can be demonstrated by a plot of temperature readings above the track system and below the track system, as shown in FIG. 21. It is apparent from the temperature plot that the temperature below the track system is maintained at a temperature below 5°C despite the temperature above the track system on which the robotic load handling device operates reaching temperatures above 10°C. As a result, one or more of the robotic load handling devices operating on the track system will not be affected by the lower temperatures in the first temperature storage zone and can largely operate at ambient temperatures when moving across to the second temperature storage zone. Thus, the radiant cooling system is able to provide a multi-temperature storage system for storing storage containers at different temperatures. In the particular example described above, the multi-temperature storage system is a dual temperature storage system providing two different temperature regions, namely a chilled and ambient temperature region. However, the radiant cooling system of the present invention is not limited to providing a chilled temperature region in the grid framework structure and can be extended to providing more than two different temperature regions within the grid framework structure. For example, the radiant cooling system can comprise a first radiant cooling system and a second radiant cooling system. The first radiant cooling system being configured to regulate the temperature of a first section of the grid framework structure at a first temperature storage zone and the second radiant cooling being configured to regulate the temperature of a second section of the grid framework structure at a second temperature storage zone. The at least one thermally insulating panel demarcates the grid framework structure into the first section (or first storage zone or first temperature storage zone) and the second section (or second storage zone or second temperature storage zone). The first temperature storage zone can be a chilled temperature storage zone and the second temperature storage zone can be a frozen temperature storage zone. An additional thermally insulating panel can optionally demarcate the grid framework structure to provide a third temperature storage zone, e.g. an ambient temperature storage zone. As the radiant cooling system comprising the first and second radiant cooling systems concentrates the cooling below the track system, one or more of the robotic load handling devices operative on the track system are able to operate at the ambient temperature. Thus, the load handling devices can access storage containers in different temperature storage zones without suffering from problems of moving between two different temperature zones.

1. A multi-temperature storage system, comprising:
A) a grid framework structure, said grid framework structure comprising:
a) a supporting framework structure comprising a plurality of storage columns, each of the plurality of storage columns being arranged to accommodate a stack of storage containers, said supporting framework structure comprising a load bearing assembly of supporting walls arranged in a three dimensional grid pattern comprising a plurality of modular storage cells for the storage of a plurality of stacks of storage containers, said at least one of the supporting walls is a thermally insulating panel being arranged to separate the plurality of storage columns into a first group of storage columns to define a first temperature storage zone and a second group of storage columns to define a second temperature storage zone;
b) a track system for guiding the movement of one or more robotic load handling devices on the grid framework structure, the track system being mounted to the supporting framework structure and comprising a plurality of tracks arranged in a grid pattern comprising a plurality of grid cells extending across the plurality of modular storage cells such that each of the plurality of modular storage cells supports a sub-group of two or more grid cells of the track system; and
B) a radiant cooling system comprising a cooling unit and a closed network of tubing in fluid communication with the cooling unit, the closed network of tubing extending in the first temperature storage zone for circulating a heat transfer fluid to exchange heat with at least a portion of the first temperature storage zone such that the first temperature storage zone is at a lower temperature than the second temperature storage zone.

2. The system of claim 1, wherein the load bearing assembly of supporting walls comprises a plurality of prefabricated frames.

3. The system of claim 1, wherein a portion of the closed network of tubing comprises a plurality of parallel tubes extending substantially horizontally in the first temperature storage zone.

4. The system of claim 3, wherein the portion of the closed network of tubing comprises a plurality of sets of parallel tubes, each set of the plurality of sets of parallel tubes extending substantially horizontally between two or more of the storage columns of the first group of the plurality of storage columns, OPTIONALLY wherein each set of the plurality of tubes being arranged in an array of parallel tubes, the parallel tubes being spaced apart within the array.

5. The system of claim 3, wherein the first temperature storage zone comprises an upper portion and a lower portion, the portion of the closed network of tubing extends in the upper portion of the first temperature storage zone to distribute the heat transfer fluid at a supplied pressure to exchange heat with the upper portion of the first temperature storage zone.

6. The system of claim 5, wherein the ratio of the height of the upper and lower portions is 1:X, where X represents the lower portion and is in the range between 1 to 10.

7. The system of claim 4, wherein a second portion of the closed network of tubing extends through at least a portion of the track system extending across the first temperature storage zone, OPTIONALLY wherein the track system comprises a plurality of track supports arranged in a grid pattern corresponding to the grid pattern of the plurality of tracks to define a track support structure, said plurality of tracks being mounted to the plurality of track supports, and wherein the second portion of the closed network of tubing extends through at least a portion of the track support structure extending across the first temperature storage zone.

8. The system of claim 7, wherein a third portion of the closed network of tubing extends below the first group of storage columns in the first temperature storage zone, OPTIONALLY wherein the system further comprises a subfloor for supporting the grid framework structure and a screed arranged on top of the subfloor in the first temperature zone, said second portion of the closed network of tubing extending within the screed.

9. The system of claim 5, wherein the lower portion of the first temperature zone is substantially free of the parallel tubes extending substantially horizontally in the first temperature storage zone.

10. The system of claim 3, wherein the closed network of tubing further comprises at least one common distribution system for distributing the heat exchange fluid from the cooling unit to each of the plurality of substantially parallel tubes, OPTIONALLY wherein the closed network of tubing further comprising at least one common return system in fluid communication with the cooling unit, and wherein at least a portion of the closed network of tubing is arranged to form one or more parallel circulation loops extending from the at least one common distribution system to the at least one common return system for circulating the heat transfer fluid from the at least one distribution system to the first temperature zone and from the first temperature zone to the cooling unit, OPTIONALLY wherein the at least one common distribution system comprises a feed manifold and the at least one common return system comprises a return manifold.

11. The system of claim 10, wherein the at least one common distribution system comprises at least one control valve to control the flow of the heat transfer fluid to one or more of the plurality of substantially parallel tubes.

12. The system of claim 1, wherein the grid framework structure further comprises a plurality of tote guides for guiding the plurality of storage containers through the grid cells of the track system, wherein the closed network of tubing extends through a portion of the plurality of tote guides in the first temperature storage zone.

13. The system of claim 12, wherein the portion of the plurality of tote guides in the first temperature storage zone comprises a plurality of sets of tote guides, each set of the plurality of sets of tote guides comprises a pair of tote guides formed as a single body.

14. The system of claim 13, wherein each set of the plurality of sets of tote guides comprises a plurality of openings that are spaced apart, and wherein at least a portion of the closed network of tubing extends through the plurality of openings.

15. The system of claim 13, wherein each set of the plurality of sets of tote guides is formed from one or more bends in a sheet metal blank extending longitudinally along the sheet metal blank to form two substantially perpendicular bin guiding plates defining two tote guides.

16. The system of any of claim 12, wherein the plurality of tote guides are arranged at diagonal opposed corners of the plurality of storage columns for guiding diagonally opposing corners of a storage container.

17. The system of claim 1, wherein the system further comprises a run-off system for capturing condensation from a portion of the closed network of tubing, said run-off system comprising a network of gutters extending substantially longitudinally along the portion of the closed network of tubing, OPTIONALLY wherein the run-off system comprises a downpipe having an inlet opening for capturing fluid from the network of gutters and an outlet opening external of the grid framework structure, OPTIONALLY wherein each of the network of gutters is downwardly inclined towards the downpipe.

18. The system of claim 1, wherein the system further comprises a shield extending across the track system above the first group of storage columns.

19. The system of claim 1, wherein the first temperature storage zone comprises an enclosure housing the first group of the plurality of storage columns, at least one wall of the enclosure comprises the thermally insulating panel, OPTIONALLY wherein the enclosure is accessible via a second enclosure having a first opening accessible externally of the second enclosure and a second opening linking the second enclosure with the enclosure, the first opening being closeable by a first door to prevent access to the second enclosure and the second opening being closeable by a second door to isolate the second enclosure from the enclosure.

20. The system of claim 1, the system further comprising a plurality of load handling devices for lifting and moving containers stacked in the stacks, the plurality of load handling devices being remotely operated to move laterally on the track system above the plurality of storage columns to access the storage containers through the grid cells, each of said plurality of load handling devices comprising:
a) a wheel assembly for guiding the load handling device on the track system;
b) a container-receiving space located above the track system; and
c) a lifting device arranged to lift a storage container from a stack into the container-receiving space.
